(19) United States
(12) Patent Application Publication
(10) Pub. No.: US 2004/0241597 A1
(43) Pub. Date: Dec. 2, 2004

(54) Method for preparing bleach-fixing processing solution for silver halide color photographic light sensitive material, starter for concentrated bleach-fixing composition and method for processing of photographic light sensitive material

(75) Inventors: Hiroaki Kobayashi, Tokyo (JP); Atsuro Yanata, Tokyo (JP); Satoshi Okano, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc., Tokyo (JP)

(21) Appl. No.: 10/852,819

(22) Filed: May 25, 2004

(30) Foreign Application Priority Data
Jun. 2, 2003 (JP) JP2003-156613
Jun. 27, 2003 (JP) JP2003-183887

(51) Int. Cl. G03C 5/16

(52) U.S. Cl. 430/400

(57) ABSTRACT

A method for preparing a bleach-fixing processing solution for a silver halide color photographic light sensitive material, the method comprising the step of:

mixing a concentrated one-part bleach-fixing composition with a starter,

wherein the concentrated one-part bleach-fixing composition contains an iron salt having an Fe(II) content of 50 to 100 mol % based on the total mol of the iron salt; and the starter contains an aminopolycarboxylic acid Fe(III) complex.

### FIELD OF THE INVENTION

The present invention relates to a method for preparing a bleach-fixing processing solution for a silver halide photographic light sensitive material (hereinafter, referred to as a photosensitive material, a color paper or a print), a starter for a concentrated one-part bleach-fixing composition, and a method for processing a photosensitive material, specifically this relates to a method for preparing a bleach-fixing processing solution (a working solution and a tank solution) which is prepared using a concentrated one-part bleach-fixing composition having an Fe(II) content in an iron salt of not less than 50 mol % and via which it is possible to prevent staining (magenta stain) in white areas of processed prints during long term storage, a starter for a concentrated one-part bleach-fixing composition and a method for processing a photosensitive material. Further, the present invention relates to a method for photographic processing of a photosensitive material, in which crystal precipitation in a replenisher tank is improved and quicker processability is enhanced.

### BACKGROUND OF THE INVENTION

Bleach-fixing compositions are used to remove developed silver in processing photosensitive materials. The process for removing developed silver includes a bleaching step of oxidizing silver grains using oxidizing agents to form silver ions, and a fixing step of leaching out silver ions produced by oxidation from photographic material. Accordingly, a bleach-fixing composition contains a bleaching agent and a fixing agent. Fixing agents generally have reducing capability, which are easily deactivated when a preservative is not concurrently present.

Sulfites are usually used as a preservative, however, such a preservative decomposes over time and even when a preservative is present, the bleaching agent and preservative react moderately with each other when each is at a relatively high concentration, leading to deteriorated performance. In light of the foregoing, a bleaching agent part and fixing agent part are conventionally designed as a two-part constitution in independent forms.

However, handling plural parts often causes complicated and troublesome work for users. Specifically, an erroneous operation in dissolution produces problems of the intended replenishing concentration not being achieved. A replenisher of a single part constitution (a so-called one-part) is therefore desired by operators, which includes all replenishing components mixed together and/is usable as a replenisher. The one-part avoids such troublesome tasks, markedly reducing the possibility of errors in the dissolution operation.

Known are two types of one-part replenishers, including a worker type which is usable as a replenisher in that form and a concentrate type which must first be diluted with water to use as a replenisher. Recently, small-scale photographic labs, so-called mini-labs having a relatively small storage area have increased, in which space for stocking replenisher solutions is limited and a concentrated solution type capable of being stored even in a relatively small space is desired rather than a worker solution type which needs a relatively large space for storage.

One-part concentration of a bleach-fixing composition is described in Patent Document 1. In this technology, a one-part constitution is enabled by including an iron salt containing an Fe(II) content of not less than 50 mol % and reducing oxidation ability of iron, restraining reaction with a fixing agent. In cases when the foregoing concentrated one-part composition is used as a replenisher, bleaching ability is not affected since sufficient time of Fe(II) returning to Fe(III) in the replenisher tank is allowed. However, in cases when the concentrated one-part composition is used to prepare a working solution (being a processing tank solution), sufficient time of Fe(II) returning to Fe(III) in the replenisher tank is not available. Therefore, to enhance bleaching ability (meaning, to return Fe(II) to Fe(III)), aeration is required (being a physical oxidation) or addition of oxidizing agents such as persulfates, peroxides or hydrogen peroxide. In the case of aeration, it takes time to obtain sufficient bleaching ability, as well as machinery and equipment resulting in higher cost.

Consequently, the other methods of addition of oxidizing agents draw attention. This addition of oxidizing agents provides immediate bleaching, however, it has been proved that the processed prints generate staining in white areas (being a magenta stain) when stored over a long time, resulting in new and major problems.

Patent Document 1: Unexamined Japanese Patent Application Publication (hereinafter, referred to as JP-A) 2002-169253.

### SUMMARY OF THE INVENTION

It is an object of the present invention to provide a method for preparing a bleach-fixing processing solution for a photosensitive material, in cases when the bleach-fixing processing solution (being a working solution and a processing tank solution) is prepared using the foregoing concentrated one-part bleach-fixing composition and the photosensitive material is processed using the processing solution, this method provides sufficient bleach-fixing capability without aeration or addition of oxidizing agents, and also prevents staining in white areas (magenta stain) of the processed prints stored over time; a starter for the concentrated bleach-fixing composition and a method for processing photosensitive materials. Another object is to provide a method for photographic processing of a photosensitive light sensitive material using a one-part concentrated bleach-fixing composition, in which precipitates in the replenisher tank, and fogging generation in unexposed areas of the color paper processing is reduced.

The foregoing problems can be achieved by the following constitution:

1. A method for preparing a bleach-fixing processing solution for a silver halide color photographic light sensitive material, the method comprising the step of:

mixing a concentrated one-part bleach-fixing composition with a starter,

wherein the concentrated one-part bleach-fixing composition contains an iron salt having an Fe(II) content of 50 to 100 mol % based on the total mol of the iron salt; and the starter contains an aminopolycarboxylic acid Fe(III) complex.

2. The method according to Item 1 above, wherein the content of the aminopolycarboxtlic acid Fe(III) complex is in the range of 0.06 to 0.25 mol per liter of the bleach-fixing processing solution, the content of which is obtained by addition as the starter.

3. The method according to Item 1 or 2 above, wherein a pH value of the starter is in the range of 3.0 to 9.0.

4. The method according to any one of Items 1-3, wherein a mol ratio of the total aminopolycarboxylic acid to the total iron ions in the starter is in the range of 1.01:1.00 to 1.10:1.00.

5. A method for processing of silver halide color photographic light sensitive material using a processing solution described in Item 1, wherein:

the processing solution is prepared from a replenisher which is prepared by using the one-part concentrated bleach-fixing composition,

the replenisher contains at least 0.05 to 0.35 mol/l of aminopolycarboxylic acid iron complex,

at least 50 mol % of the aminopolycarboxylic acid iron complex is an Fe(II) complex, and

an exposed surface area ratio of a bleach-fixing replenisher tank is 50 to 500 cm²/l.

6. The method according to Item 5 above, wherein an amount of Fe(II) complex in the aminopolycarboxylic acid iron complex is not less than 70 mol %.

7. The method according to Item 5 or 6 above, wherein a replenishing amount of the replenisher is 20 to 120 ml per m² of the photographic light sensitive material.

8. The method according to any one of Items 5-7, wherein a solution circulation amount per minute in the bleach-fixing processing tank is 50 to 300% based on the total processing solution volume.

9. The method according to any one of Items 5-8, wherein a concentration factor of the one-part concentrated bleach-fixing composition is 1.2 to 5.

10. A starter for the one-part concentrated bleach-fixing composition for silver halide color photographic light sensitive material, containing an iron salt having an Fe(II) content of 50 to 100 mol %, wherein the starter contains an aminopolycarboxylic acid Fe(III) complex.

11. The starter according to Item 10 above, wherein content of an aminopolycarboxylic acid Fe(III) complex in the starter is in the range of 0.2 to 2.0 mol/l.

12. The starter according to Item 10 or 11, wherein a pH value of the starter is in the range of 3.0 to 9.0.

13. The starter according to any one of Items 10-12, wherein the mol ratio of the total aminopolycarboxylic acid to the total iron ions in the starter is in the range of 1.01-1.00 to 1.10-1.00.

14. A method for processing a silver halide color photographic light sensitive material using a bleach-fixing processing solution prepared by the method for preparation of the bleach-fixing processing solution described in any one of Items 1-4.

15. The method according to Item 14, wherein at least 90 mol % of silver halides in the silver halide color photographic light sensitive material is silver chloride.

16. A method for processing a silver halide color photographic light sensitive material, wherein the starter described in any one of Items 10-13 is packed into a package material having an oxygen transmission factor of not more than 400 ml/m²·atm·day.

That is, the inventor of this invention found that, in cases when a bleach-fixing processing solution (being a working solution or a tank solution) was prepared using a concentrated one-part bleach-fixing composition comprising an iron salt having an Fe(II) content of not less than 50 mol %, it was proved that staining in white areas (magenta stain) was generated on the prints stored over time, said prints were processed using the processing solution, and a reduced effect for this problem was obtained by using a starter containing an aminopolycarboxylic acid Fe(III) complex, and thereby offers this invention. Further, according to the compositions of the present invention, even using a concentrated one-part bleach-fixing composition, both problems of generation of precipitation in the replenisher tank and reduction of fogging generation in unexposed areas in a color paper processing are solved simultaneously.

### BRIEF DESCRIPTION OF THE DRAWINGS

FIG. 1: A schematic block diagram of an automated processor which is preferably employed in this invention

FIG. 2: A schematic block diagram of an example of a circulation system used in the above processor

### DESCRIPTION OF PREFERRED EMBODIMENTS

The present invention will be detailed as follows.

An iron salt in the concentrated bleach-fixing composition of this invention is contained in the form of an iron complex with an aminopolycarboxylic acid. The preferable aminopolycarboxylic acid is represented by following Formulas (I), (II), (III) or (IV).

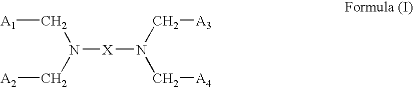

wherein each of A₁-A₄ may be the same or different and is —CH₂OH, —COOM or —PO₃M₁M₂; M, M₁ and M₂ are each a hydrogen atom, an alkali metal (such as sodium and potassium) or other cations (such as ammonium, methyl ammonium and trimethyl ammonium); and X is a substituted or unsubstituted alkylene group having 3-6 carbon atoms.

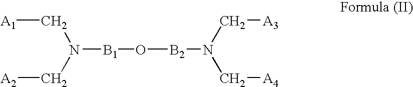

wherein each of A₁-A₃ is the same as defined in foregoing Formula (I), n is an integer of 1-8, B₁ and B₂ may be the same or different and are each substituted or unsubstituted alkylene group having 2-5 carbon atoms.

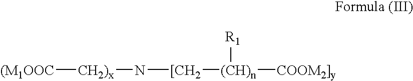

wherein R₁ is a hydrogen atom or a hydroxyl group, M₁ and M₂ are each the same as in Formula (I), n is 1 or 2, is 2 or 3, y is 0 or 1, and the sum of x plus y is always 3.

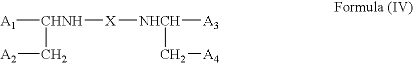

wherein each of A1-A4 is the same as defined in foregoing Formula (I), X is a substituted or unsubstituted alkylene group having 2-6 carbon atoms or —(B₁O)ₙ—B₂, B1 and B2 may be the same or different and are each a substituted or unsubstituted alkylene group having 1-5 carbon atoms, and n is an integer of 1-8.

Preferably specific examples of compounds represented by foregoing Formula (I) are shown below.

I-1 1,3-propanediaminetetraacetic acid

I-2 2-hydroxy-1,3-propanediaminetetraacetic acid

I-3 2,3-propanediaminetetraacetic acid

I-4 1,4-butanediaminetetraacetic acid

I-5 2-methyl-1,3-propanediaminetetraacetic acid

I-6 N-(2-hydroxyethyl)-1,3-propanediaminetriacetic acid

I-7 1,3-propanediaminetetrakismethylenephosphonic acid

I-8 2-hydroxy-1,3-propanediaminetetrakismethylenephosphonic acid

I-9 2,2-dimethyl-1,3-butanediaminetetraacetic acid

I-10 2,4-butanediaminetetraacetic acid

I-11 2,4-pentanediaminetetraacetic acid

I-12 2-methyl-2,4-pentanediaminetetraacetic acid

The iron complexes of I-1-I-12 are optionally used as a salt of sodium, potassium or ammonium.

Preferably specific examples of compounds represented by foregoing Formula (II) are shown below.

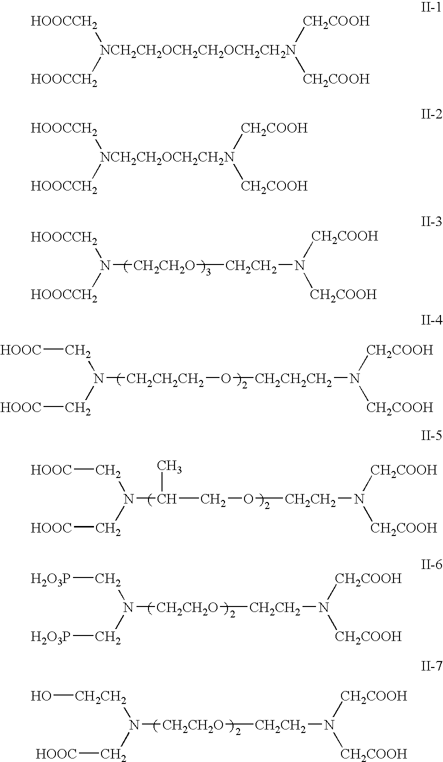

The iron complexes of II-1-II-7 are optionally used as a salt of sodium, potassium or ammonium.

As specific examples of compounds represented by Formula (III), listed are (III-1) nitrilomonopropionodiacetic acid, and (III-2) nitrilotriacetic acid. The iron complexes of III-1 and III-2 are optionally used as a salt of sodium, potassium or ammonium.

Specific examples of compounds represented by Formula (IV) are listed below, but are not limited to these examples.

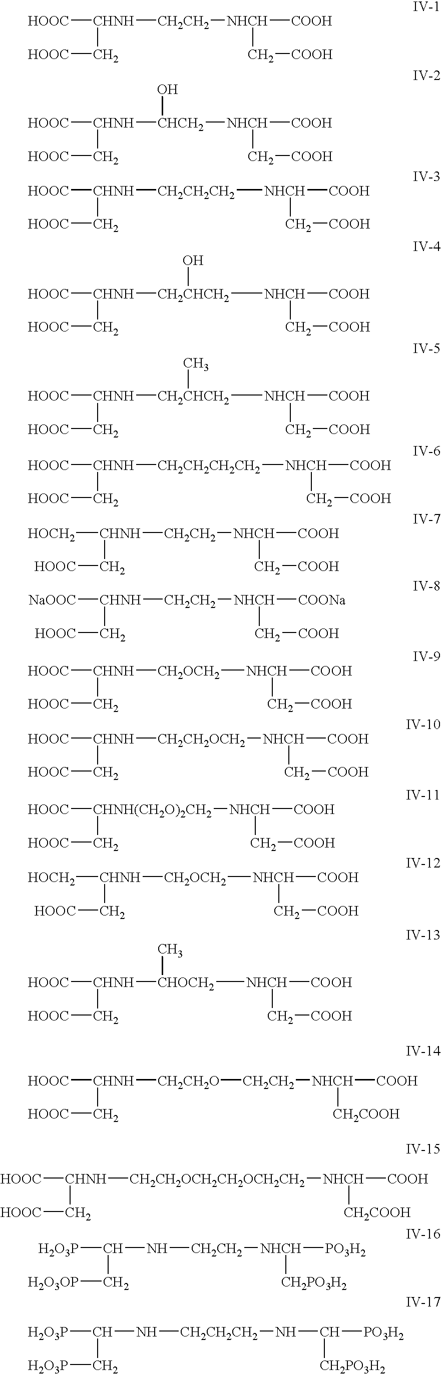

The iron complexes of IV-1-IV-17 are optionally used as a salt of sodium, potassium or ammonium.

The amount of the iron salts contained in the concentrated bleach-fixing component is 0.2-4.0 mol per liter as an iron ion amount from the viewpoint of solubility, and preferably 0.3-3.0 mol/l.

Further, the foregoing aminopolycarboxylic acid iron complexes may be used alone or in combination of two or more.

The aminopolycarboxylic acid iron complexes may be provided by addition of an aminopolycarboxylic acid as a ligand along with an inorganic iron salt.

In this invention, in a concentrated one-part bleach-fixing composition, ferrous complexes of the following compounds may be employed as a bleaching agent.

(V-1) Ethylenediaminetetraacetic acid

(V-2) Trans-1,2-cyclohexanediaminetetraacetic acid

(V-3) Dihydroxyethyl glycine

(V-4) Ethylenediaminetetrakismethylenephosphonic acid

(V-5) Nitrilotrismethylenephosphonic acid

(V-6) Diethylenetrisaminepentakismethylenephosphonic acid

(V-7) Diethylenetriaminepentaacetic acid

(V-8) Ethylenediaminediorthohydroxyphenylacetic acid

(V-9) Hydroxyethylethylenediaminetriacetic acid

(V-10) Ethylenediaminepropionic acid

(V-11) Ethylenediaminediacetic acid

(V-12) Hydroxyethyliminodiacetic acid

(V-13) Nitrilotriacetic acid

(V-14) Nitrilotripropionic acid

(V-15) Triethylenetetraminehexaacetic acid

(V-16) Ethylenediaminetetrapropionic acid

(V-17) 1,3-propylenediaminetetraacetic acid

(V-18) Glycol ether diaminetetraacetic acid

Of these compound examples, preferred are (V-1), (V-7) and (V-17), but specifically preferred is (V-1).

Further, preferably employed are Fe(III) complexes of the compounds such as (A-I-1)-(A-I-12), (A-II-1)-(A-II-17) and (A-III-1)-(A-III-34), all of which are described in JP-A 5-224378.

Of the compounds described above, specifically preferred are (A-I-1) and (A-I-2), (A-II-1), (A-II-3) and (A-II-14), and (A-III-1), (A-III-2) and (A-III-6).

An aminopolycarboxylic acid iron complex is employed at least 0.05 mol per liter of the tank solution of the bleach-fixing solution, preferably contained in the range of 0.05-0.35 mol, and more preferably in the range of 0.10-0.25 mol/L.

An aminopolycarboxylic acid iron(III) complex may be reduced with a reducing agent such as dithionous acid sodium salt to achieve an Fe(II) content of not less than 50 mol %. Alternatively, it can be achieved by adjusting the ratio of an inorganic Fe(II) salt (or ferrous salt) to an Fe(III) salt (or ferric salt).

The foregoing ferrous salts include, for example, ferrous sulfate, ferrous chloride, ferrous oxalate, and ferrous oxide. As specific examples thereof, listed are ammonium ferrous sulfate, sodium ferrous sulfate, ferrous chloride, ferrous sulfate, ferrous acetate, ferrous oxalate, and ferrous oxide.

Ferric salts include, for example, ferric nitrate, ferric chloride, ferric bromide, Fe(III) trissulfate tri M1, and Fe(III) sulfate M1 (in which M1 is ammonium, potassium, sodium or a hydrogen atom). Specific examples thereof include ferric nitrate, ferric chloride, ferric bromide, triammonium iron(III) trissulfate, tripotassium iron(III) trissulfate, trisodium iron(III) trissulfate, potassium iron(III) sulfate, sodium iron(III) sulfate, and ammonium iron(III) sulfate.

Further, in order to enhance a chelate configuration of the aminopolycarboxylic acid iron complex, to the concentrated bleach-fixing composition of this invention, it is preferred to add a carboxylic acid represented by Formula (A) and a compound selected from imidazole derivatives represented by Formula (B).

R—(COOM)n Formula (A)

wherein R is a single bond or a n-valent group; n is 1 or 2; M is a hydrogen atom, an alkali metal or an ammonium group; in cases when n is 1, a preferable monovalent group represented by R is an alkyl group, an alkenyl group, a cycloalkyl group or a phenyl group which has 1-6 carbon atoms and may be substituted by a hydroxyl group, and when n is 2, a preferable divalent group represented by R is an alkylene group, an alkenylene group, an alkyleneoxyalkylene group, an alkylenethioalkylene group, a cycloalkylene group, or a phenylene group; and the alkylene group and alkenylene group have 1-6 carbon atoms which may be substituted by a hydroxyl group or a carboxyl group.

Thr alkylene group constituting the alkyleneoxyalkylene group or alkylenethioalkylene group has 1-4 carbon atoms and may be substituted by one or two alkyl groups having 1-3 carbon atoms. The cycloalkylene group (having 3-7 carbon atoms) and phenylene group may be substituted by one or two alkyl groups having 1-3 carbon atoms, hydroxyl groups or carboxyl groups.

Specific examples of a mono- or dicarboxylic acid compound represented by foregoing Formula (A) include glycolic acid, citric acid, and tartaric acid, as well as, dicarboxylic acids shown by A-1-A-17 of the following exemplified compounds, but compounds represented by Formula (A) are not limited to the foregoing specific compounds. These compounds may be used in combination of more than two.

(A-1) HOOCCH₂C(OH)(COOH)CH₂COOH

(A-2) HOOC(CHOH)₂COOH

(A-3) HOOCCH₂COOH

(A-4) HOOCCH(OH)CH₂COOH

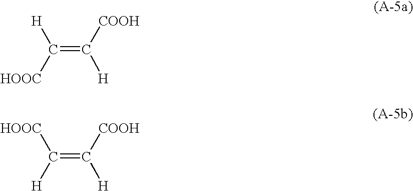

(A-6) HOOCCH₂CH₂COOH

(A-7) (COOH)₂

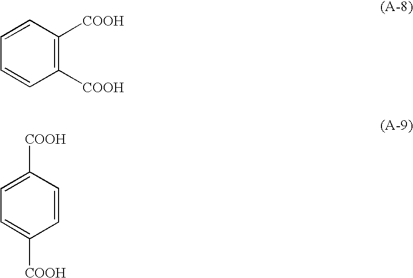

(A-10) NaOOCCH═CHCOONa

(A-11) KOOCCH═CHCOOK

(A-12) H₄NOOCCH═CHCOONH₄

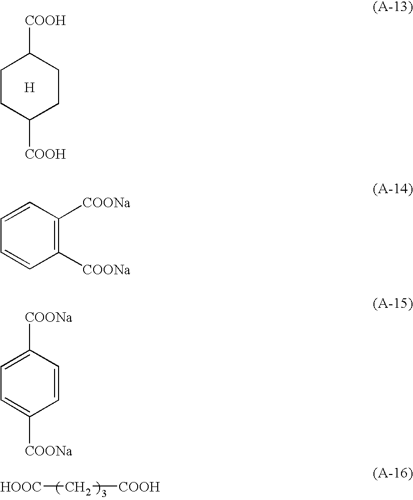

(A-17) HOOCCH₂OCH₂COOH

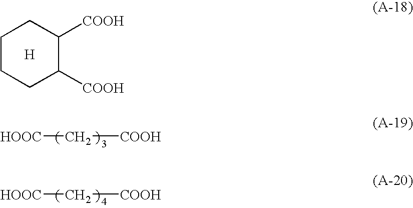

(A-21) HOOCC≡CCOOH

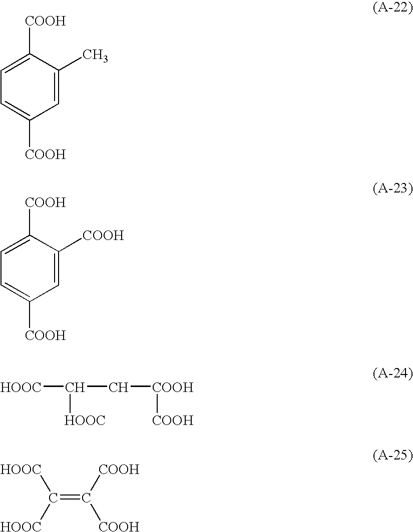

(A-26)

HO—CH₂—COOH

(¹R)ₙY Formula (B)

wherein R¹ is a hydrogen atom, an alkyl group having 1-3 carbon atoms, which may be substituted by an amino group or a hydroxyl group, an alkenyl group, or a halogen atom, provided that plural R¹ may be the same or different. The amino group represented by R¹ may be substituted by one or two methyl or ethyl groups, and the alkyl or alkenyl group may be substituted by an alkyl group having 1-3 carbon atoms; n is an integer of 1-3; and Y is an imidazolyl group.

Specific examples of imidazole compounds represented by foregoing Formula (B) are shown below but the compounds used in this invention, and represented by Formula (B), are not limited to these.

(B-1) 1-methylimidazole

(B-2) 2-methylimidazole

(B-3) 4-methylimidazole

(B-4) 4-(2-hydroxyethyl) imidazole

(B-5) 4-(2-aminoethyl) imidazole

(B-6) 2-(2-hydroxyethyl) imidazole

(B-7) 2-ethylimidazole

(B-8) 2-vinylimidazole

(B-9) 4-propylimidazole

(B-10) 2,4-dimethylimidazole

(B-11) 2-chloroimidazole

(B-12) 4,5-di(2-hydroxyethyl) imidazole

(B-13) imidazole

In cases when the dicarboxylic acid represented by Formula (A) is added to the concentrated bleach-fixing composition, the dicarboxylic acid may exist together with acetic acid which is usually added as a buffering salt. Further, acetic acid may be reduced or replaced by the dicarboxylic acid. In the case of coexistence, the compound represented by Formula (B) is added in the amount of 0.2-1.5 times that of the acetic acid (being in a mol ratio), but preferred is 0.5-1.0 times. Further, in the case of replacement, the amount of the compound is 0.4-2.5 times that of the replaced acetic acid (being also in mol ratio), and preferably 0.8-1.5. The total added amount of acetic acid and the dicarboxylic acid can be in a wide range of concentration as long as it provides sufficient buffering capability. The mol ratio is preferably 0.1-2.0 times that of a mol of the aminopolycarboxylic acid iron complex, and more preferably 0.5-2.0.

The preferable mol ratio of the compounds of Formula (B) added to the bleach-fixing composition is 0.2-2.0 times that of a mol of the aminopolycarboxylic acid iron complex, and more preferably 0.5-1.5.

The fixing agents of the concentrated bleach-fixing composition are well known fixing agents which are alkali metal salts, or ammonium salts of thiosulfates, such as sodium thiosulfate and ammonium thiosulafate, and thiocyanates such as sodium thiocyanate, and ammonium thiocyanate. In the bleach-fixing composition, the amount of major fixing agents of a thiosulfate and a thiocyanate is in the form of a mol ratio of the tiocyanate to thiosulfate being in the range of 40-100 mol %, thereby achieving the desired effects of this invention.

Further, from the viewpoint of solubility, specifically preferred are, of thiosulfates, ammonium thiosulfate, and of thiocyanates, ammonium thiosulfate. The amount of fixing agents per liter of the bleach-fixing composition is preferably 0.5-4.0 mol, and more preferably in the range of 0.5-3.0.

The bleach-fixing composition may also contain other silver halide solvents. Such secondary silver halide solvents secondarily usable in this invention are water-soluble compounds, including, for example, thioether compounds such as ethylenebisthioglycolic acid and 3,6-dithia-1,8-octanediol, and thioureas such as thiourea and ethylenethiourea. These compounds may be used alone or in combination.

The bleach-fixing composition usable in this invention may further contain a compound promoting desilvering to achieve reducing the processing time and enhancing the desilvering capability. Compounds suitable for such purposes include, for example, 1,2,4-triazolium-3-sulfide type mesoion compounds (e.g., 1,4,5-trimethyl-1,2,4-triazolium-3-sulfide), as described in JP-A Nos. 8-297356 and 8-137070; RSO₂M type sulfinic acids (in which R is an alkyl, cycloalkyl, alkenyl, aralkyl or aryl group; M is a hydrogen atom, an alkali metal atom, or an ammonium group, e.g., phenylsulfinic acid), as described in JP-A 8-292510; and 3-mercapto-1,2,4-triazole type compounds (e.g., 3-mercapto-1,2,4-triazole-1-methylsulfonic acid), as described in JP-A 9-5964. These compounds may be used alone or in combination and are commonly used in the range of 0.001-0.1 mol per liter.

To the concentrated bleach-fixing composition, it is preferable to add the compounds represented by Formula (FA) or (FB) described in JP-A 3-243948, to achieve a so-called ammonia-free system. In addition, from the bleach-fixing solution used in the processing method of this invention, silver recovery may be conducted with any of the well known methods.

Further, to the concentrated bleach-fixing composition a silver salt forming compound may be added to prevent formation of silver sludge. Compounds suitable for such a purpose include, for example, N-amino substituted or N-alkoxy substituted guanidine derivatives (which may be substituted by an alkyl group), e.g., N-(di-n-butylaminopropyl)guanidine, and N-(di-n-propylaminoethyl)guanidine, as described in JP-A 8-204980; 2-mercaptoazole derivatives and 2-mercaptopyrimidine derivatives, e.g., 2-mercapto-5-acetoamidothiadiazole, and 2-mercapto-4-methyl-5-amino-pyrimidine, as described in JP-A No. 9-211820. These compounds may be used alone or in combination, and are commonly used in the range of 0.001-0.1 mol per liter.

Next, described will be a concentration factor of the bleach-fixing composition related to this invention. A concentration factor is usually used as a practical measure indicating the extent of concentration of a concentrated liquid processing composition. The concentration factor can be represented by the volume ratio of a processing solution obtained by diluting a processing composition with water to be used as an intended working solution in place of the original processing composition. Accordingly, the concentration factor varies depending on the concentration of the working solution, even if having the same processing composition. The concentration factor of the concentrated bleach-fixing composition related to this invention is preferably in the range of 1.0-5.0, and more preferably 1.2-3.0.

In the concentrated bleach-fixing composition of this invention, other than these fixing agents, a pH buffering agent comprising various salts may contain only one or more than two kinds. Further, it is preferred that an alkali halide or an ammonium halide, for example, a re-halogenating agent such as potassium bromide, sodium bromide, sodium chloride and ammonium bromide is incorporated. Further, alkylamines or polyethylene oxides which are known to be added to the general bleach-fixing solution may be included as appropriate.

The concentrated bleach-fixing composition related to this invention preferably exhibits a pH value of 3.0-9.0, and more preferably 4.0-8.5. A lower pH enhances bleaching ability but accelerates deterioration of the solution and leuco dye formation, and a higher pH retards bleaching. To adjust the pH, optionally added may be hydrochloric acid, sulfuric acid, nitric acid, bicarbonates, ammonia, caustic potash, caustic soda, sodium carbonate, and potassium carbonate.

Further, to the concentrated bleach-fixing composition, added may be other various fluorescent brightening agents, defoaming agents, surface active agents, polyvinyl pyrrolidone and organic solvents, such as methanol.

In the concentrated bleach-fixing composition, contained as a preservative may be sulfite ion releasing compounds such as sulfites (e.g., sodium sulfite, potassium sulfite, and ammonium sulfite), bisulfites (e.g., ammonium bisulfite, sodium bisulfite, and potassium bisulfite), metasulfites (potassium metasulfite, sodium metasulfite, and ammonium metasulfite), and arylsulfinic acids such as p-toluenesulfinic acid and m-carboxybenzenesulfinic acid. The content of these compounds, which is represented by an equivalent converted to sulfite ion or sulfinic acid ion, is preferably 0.02-0.8 mol/l.

As a preservative of the concentrated bleach-fixing composition, added may be ascorbic acid, or a carbonyl bisulfite adduct or other carbonyl compounds other than the foregoing compounds.

Further incorporated may be a buffering agent, a chelating agent, a defoaming agent and a fungicide, according to need. The concentrated bleach-fixing composition preferably does not contain substantial amount of ammonium cations from the viewpoint of odor. “Does not contain substantial amount of” means the content of ammonium cations is not more than 0.05 mol/l.

The bleach-fixing replenisher tank used in the processing method of this invention is to have an exposed surface area ratio of 50-500 cm²/liter.

Generally, the exposed surface area ratio means the ratio of S/B of the exposed surface area S (cm²) to the processing tank volume B (liter: L). In this invention, the exposed surface area ration of the replenisher tank is 50-500 cm². In cases when the exposed surface area ratio is less than these values, fogging of the photosensitive material in unexposed areas, specifically on color paper, is generated, and inversely, exceeding 500 cm²/L, results in precipitates in the replenisher tank. In this invention, the foregoing exposed surface area ratio is specifically preferred to be 80-400 cm²/L to achieve the desired effects of this invention.

The circulated amount of the solution described in Item 4 above is the amount of the processing solution supplied to the bleach-fixing processing tank per minute, and the total amount of the processing solution is the total volume of the bleach-fixing processing tank including the pump and the piping. In this invention, the circulated amount of the solution is preferably 50-300% of the total amount of the processing solution, and more preferably 100-250%.

In the method using the bleach-fixing solution prepared from the concentrated bleach-fixing composition of this invention, agitation is preferably conducted following the procedure described in JP-A 3-33847, page 8, right upper column, line 6 to the left lower column, line 2.

In the desilvering process, preferred is vigorous agitation. Specific methods for vigorous agitation include, for example, a method of allowing a jet flow to impinge the emulsion surface of a photosensitive material, as described in JP-A 62-183460; a method of enhancing a stirring efficiency by means of rotation, as described in JP-A 62-183461; a method in which the photosensitive material is moved, while bringing a wiper blade into contact with the emulsion-side surface of the photosensitive material to cause turbulent flow near the surface to enhance the stirring effect; and a method of increasing the circulation amount of the entire processing solution. Vigorous agitation accelerates supplying of the bleaching agent and fixing agent into the interior of the emulsion layer, resulting in an enhanced desilvering rate. Further, the foregoing means of increasing agitation is more effective in cases when using a bleach-promoting agent, leading to a markedly increased desired effect or employing the fixation-inhibiting action of a bleach-promoting agent.

Automated processors used in this invention are preferably provided with the means for transporting photosensitive material, described in JP-A Nos. 60-191257, 60-191258 and 60-191259. As described in foregoing JP-A 60-191257, such a transporting means markedly reduces carry-in of the processing solution from the front bath to the rear baths, effectively preventing deterioration of performance of the processing solution. Such an effect is specifically effective in shortening the processing time in the respective processing steps and reducing the replenishing amount of the respective processing solutions.

Further, in this invention, in cases when the so-called cross-over time between the color development processing tank (also known as a color development tank) and the bleach-fixing processing tank (also called a bleach-fixing tank) is preferably within 10 sec., and more preferably within 7 sec., it is effective in preventing bleach fogging, which is a different effect from that of this invention.

From the viewpoint of the effect of this invention, it is preferable that the concentrated bleach-fixing composition of this invention substantially contains no acetic acid.

Next, a starter related to this invention will be described. The expression “a starter of this invention” is a processing composition which is required when the bleach-fixing processing solution (being a working solution and a tank solution) is prepared from a concentrated composition as a replenisher.

It is a must that the starter of this invention contains an Fe(III) complex of an aminopolycarboxylic acid represented by foregoing Formula (I), (II), (III) or (IV).

Further, from the view point of handling and precipitation after storage, the aminopolycarboxylic acid Fe(III) complex contained in the starter is preferably in the range of 0.2-2.0 mol per liter, and more preferably in the range of 0.5-2.0 mol. It is preferable that the content of the aminopolycarboxylic acid Fe(III) complex in the starter and the added amount of the starter are determined so that the content of the aminopolycarboxylic acid Fe(III) complex is in the range of 0.06-0.25 mol per liter of the bleach-fixing processing solution prepared hereby. In cases when it is less than 0.2 mol, the effects of this invention are lowered, and when it exceeds 2.0 mol, though the effects of this invention are not changed, the edge staining deteriorates. “Edge staining” in this invention means staining at cut end surfaces (being edge portions) of the paper substrate for a photosensitive material.

The aminopolycarboxylic acid Fe(III) complex in the foregoing starter may be added in the form of the foregoing aminopolycarboxylic acid as the ligand and the foregoing inorganic Fe(III) salt. Further, the mol ratio of the total aminopolycarboxylic acid to the total iron ions in the starter of this invention is preferably in the range of 1.01:1.00-1.10:1.00 from the viewpoint of preventing edge staining and stability of the chelating configuration, and is more preferably 1.03:1.00-1.06:1.00. Further, other Fe(III) chelate type bleaching agents may be incorporated.

The pH value of the starter related to this invention is preferably in the range of 3.0-9.0 from the viewpoint of the desired effects of this invention, and solution stability, but is more preferably 4.5-8.0. To adjust the pH, added may be hydrochloric acid, sulfuric acid, nitric acid, bicarbonates, ammonia, caustic potash, caustic soda, sodium carbonate, and potassium carbonate, based on need. Further, the pH may be adjusted using a buffering agent. As such buffering agents, listed are dicarboxylic acids represented by foregoing Formula (A) and the imidazole derivatives represented by foregoing Formula (B). Further, the starter preferably contains substantially no ammonium cations from the viewpoint of odor. “Contain substantially no” means that the content of ammonium cations is not more than 0.05 mol/l.

The concentrated bleach-fixing composition or the starter related to this invention may contain the following compounds to enhance whiteness of photographic prints right after processing.

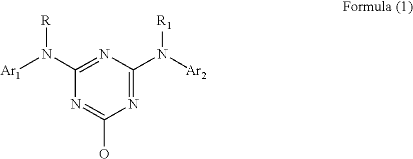

wherein Ar₁ and Ar₂ are independently a carbocyclic group or a heterocyclic group containing at least two solubilization groups in one or both sides of an aromatic group; Q is hydrogen, a hydroxyl group, a thiol group, a carboxyl group, a sulfo group, a —NR₂R₃ group, an —OR₂ group or a halo group; R and R₁ are independently hydrogen, an alkyl group having 1-3 carbon atoms, or a hydroxyalkyl group having 1-3 carbon atoms, while R₂ and R₃ are independently hydrogen, an alkyl group or a phenyl group. Preferable specific examples of the compounds represented by Formula (1) are listed below.

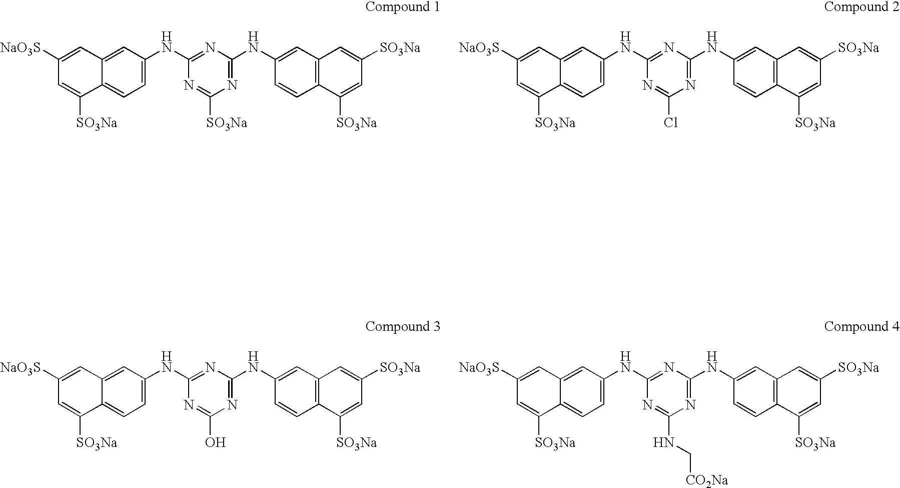

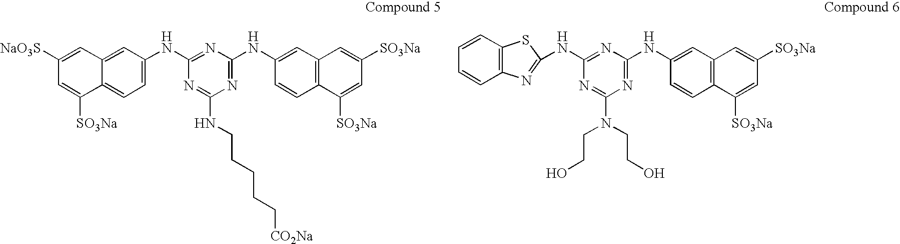

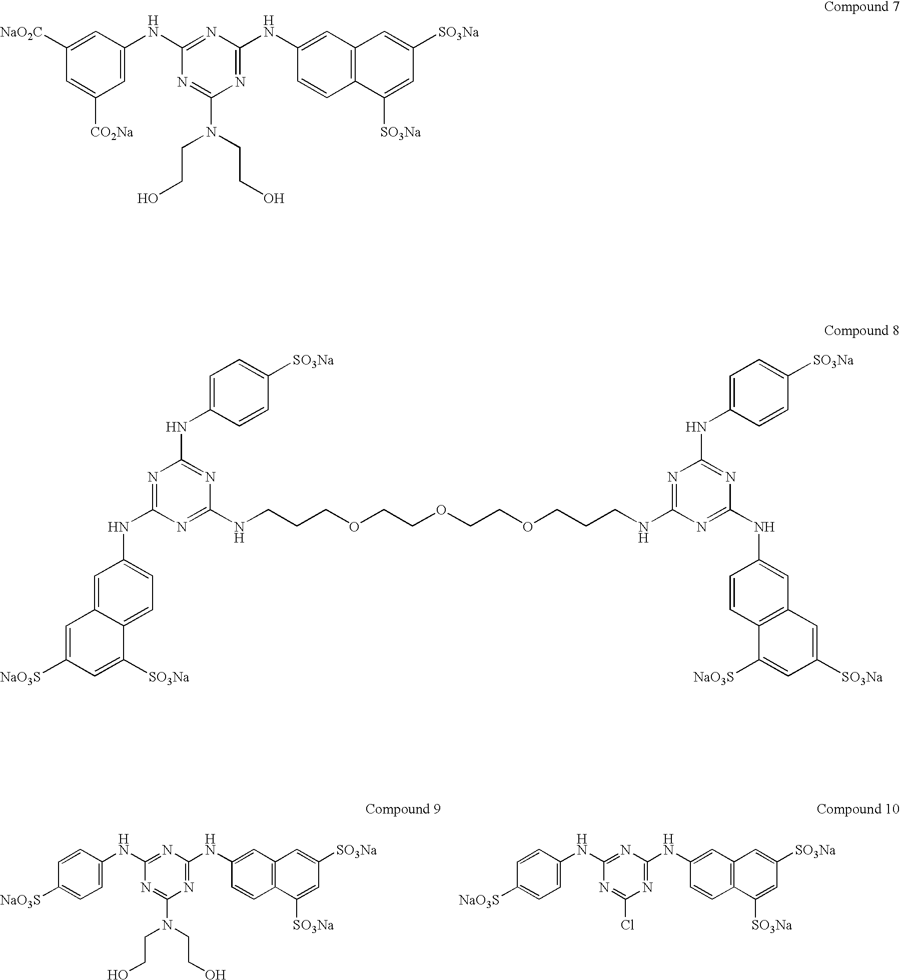

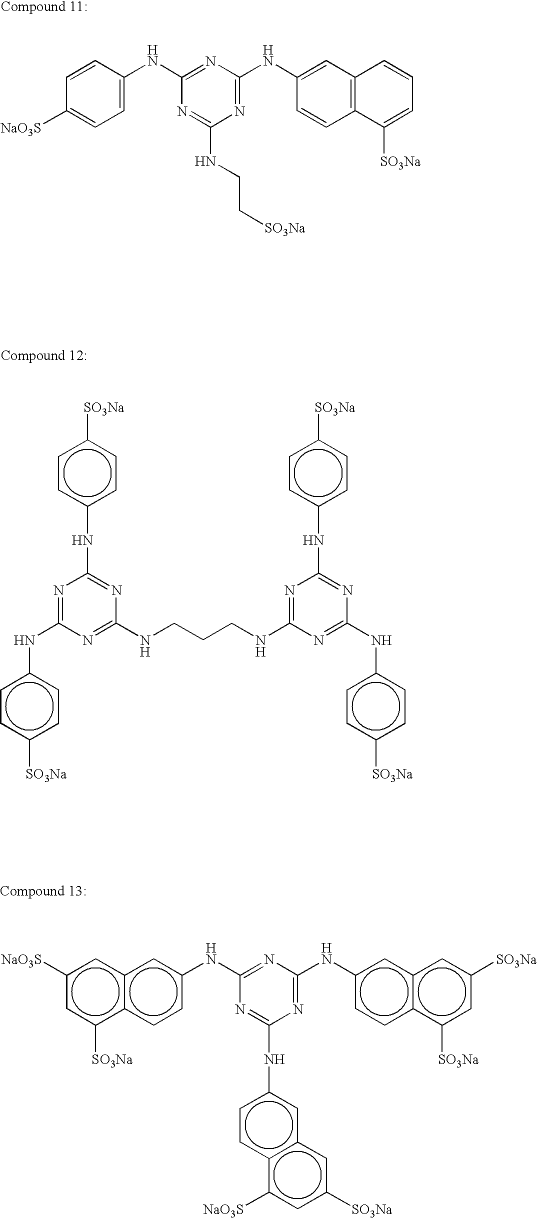

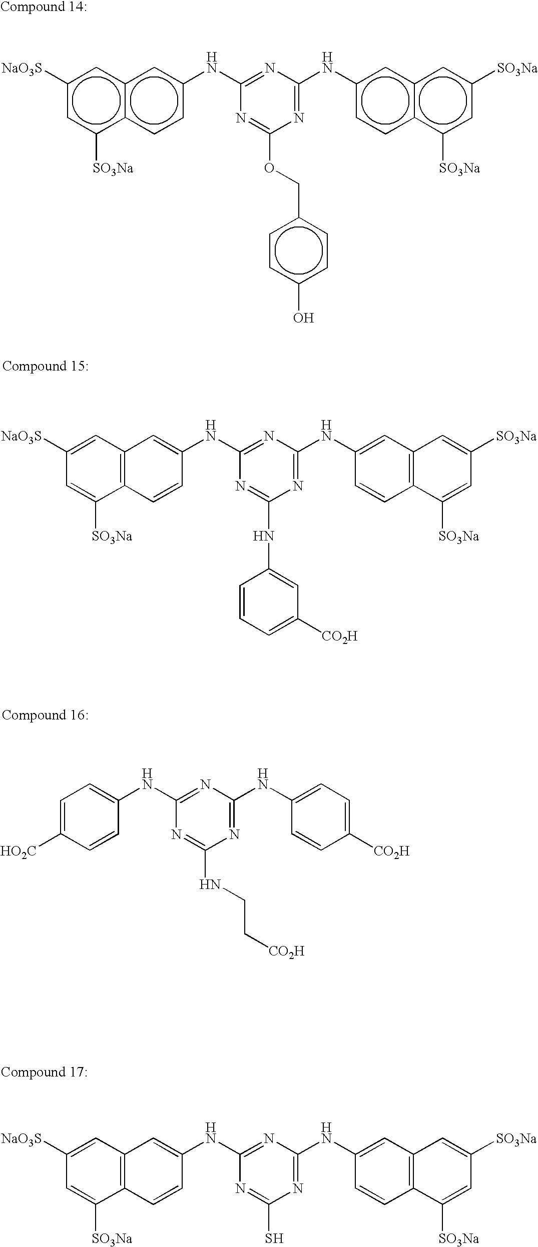

Formula (2)

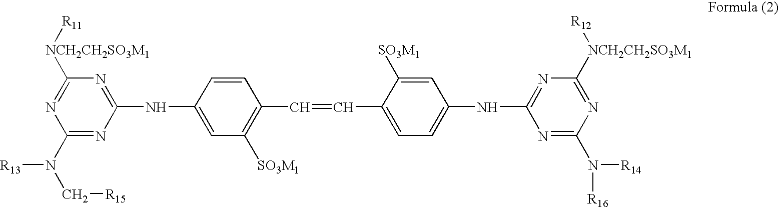

wherein R₁₁ and R₁₂ are each independently a hydrogen atom or an alkyl group; R₁₃ and R₁₄ are each independently a hydrogen atom, an alkyl group or an aryl group; R₁₅ is an alkyl group having at least one asymmetric carbon atom, or a group represented by following Formula (2-a); R₁₆ is an alkyl group having at least one asymmetric carbon atom, or a group represented by following Formula (2-b); M₁ ia a hydrogen atom, an alkali metal atom, an alkaline-earth metal atom, an ammonium group or a pyridinium group; and R₁₃ and R₁₅, and R₁₄ and R₁₆ may combine with each other to form a ring.

—CH₂O(CH₂CH₂O)ₙ₁₁H Formula (2-a)

wherein n₁₁ is an integer of 1-3.

—(CH₂CH₂O)ₙ₁₂H Formula (2-b)

wherein n₁₂ is an integer of 2-4.

Preferable specific examples of the compounds represented by Formula (2) are listed below.

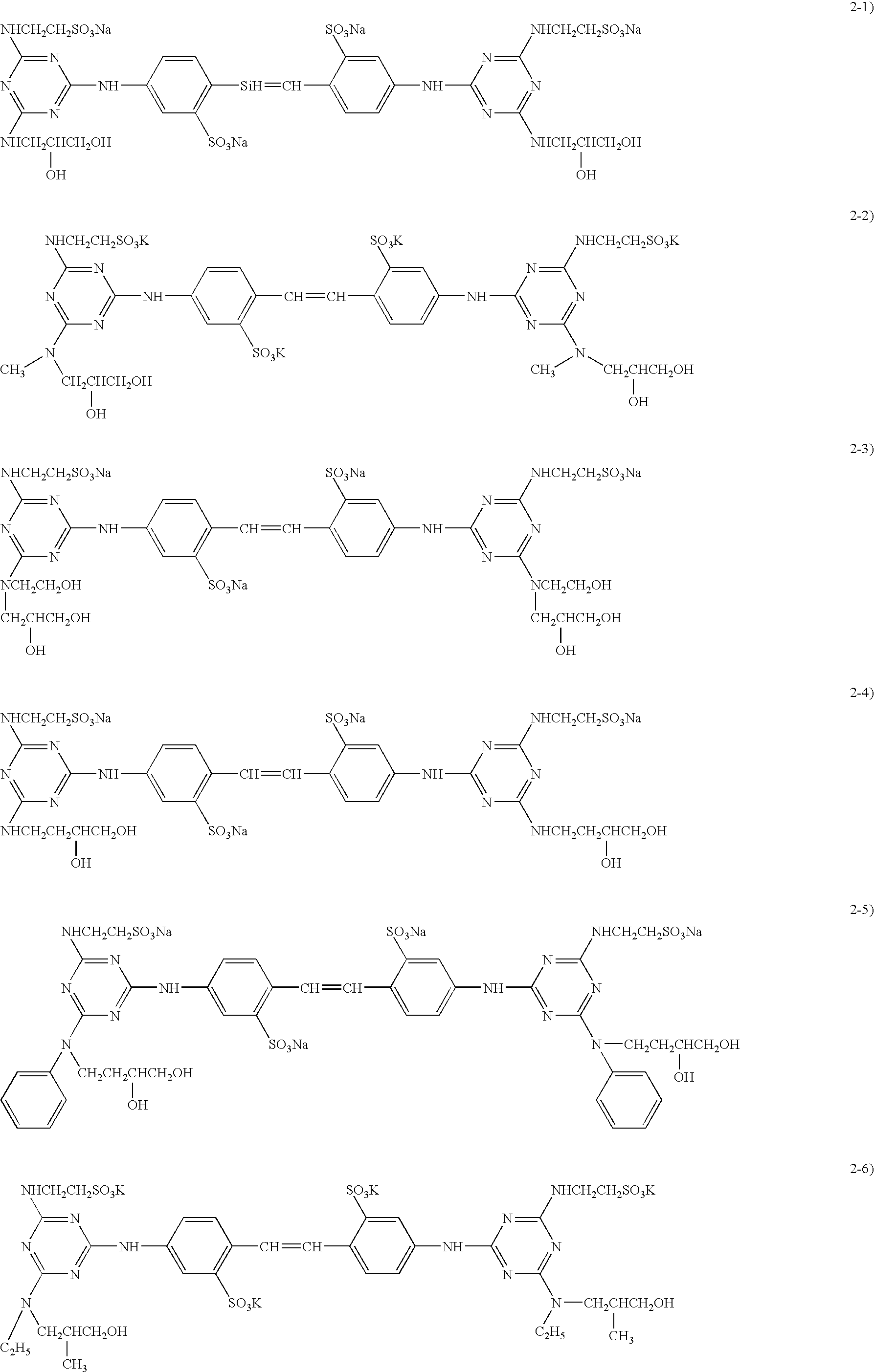

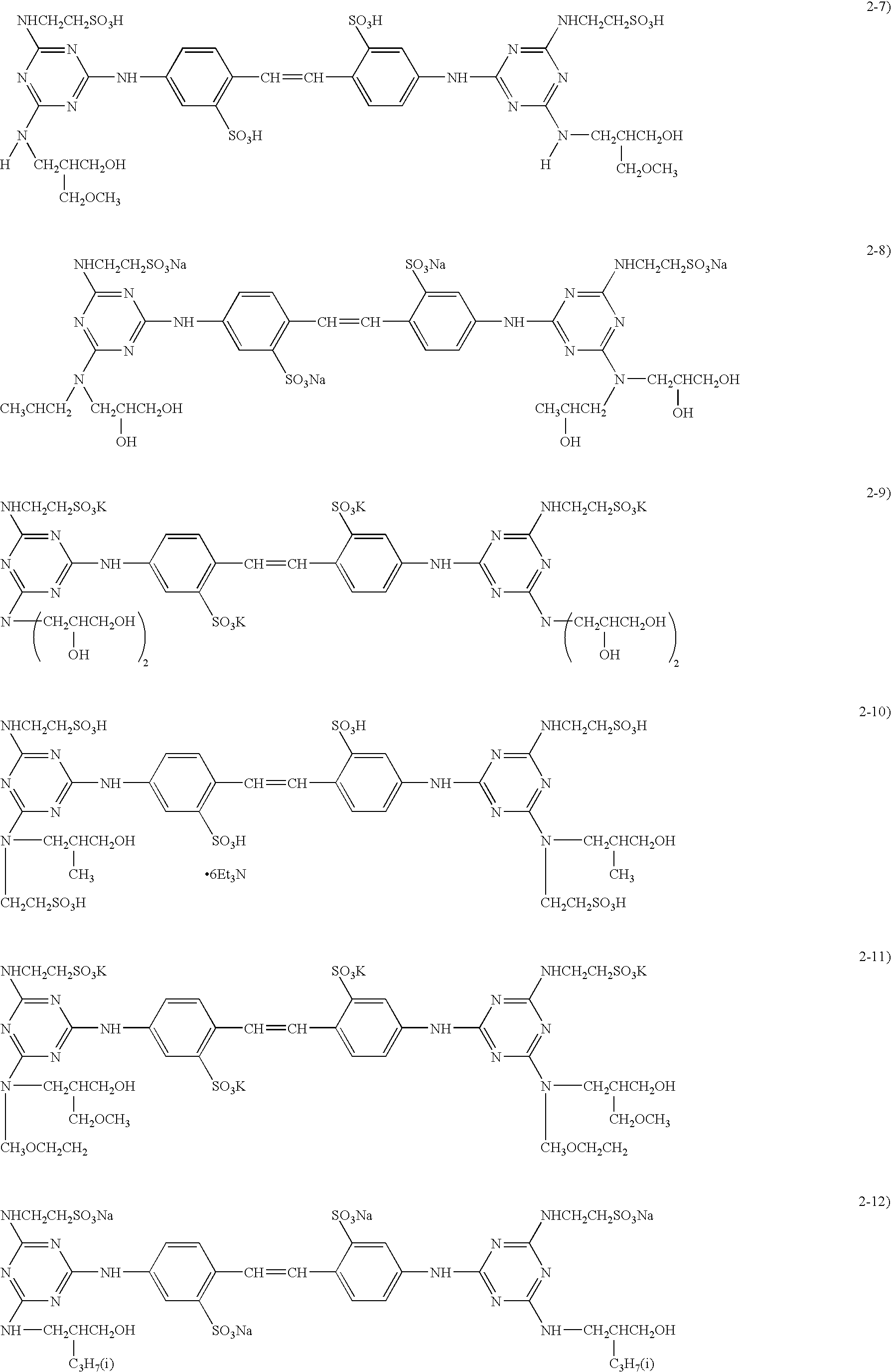

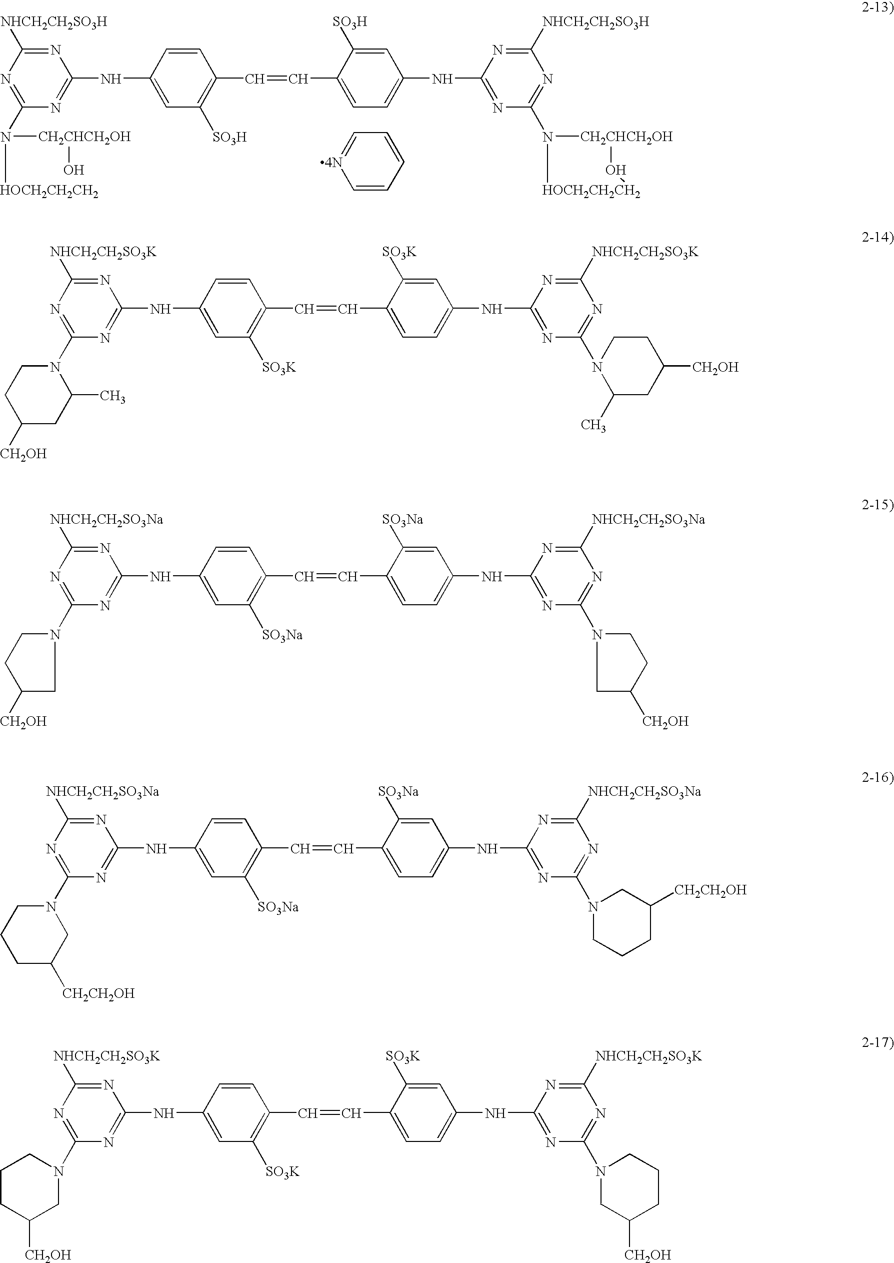

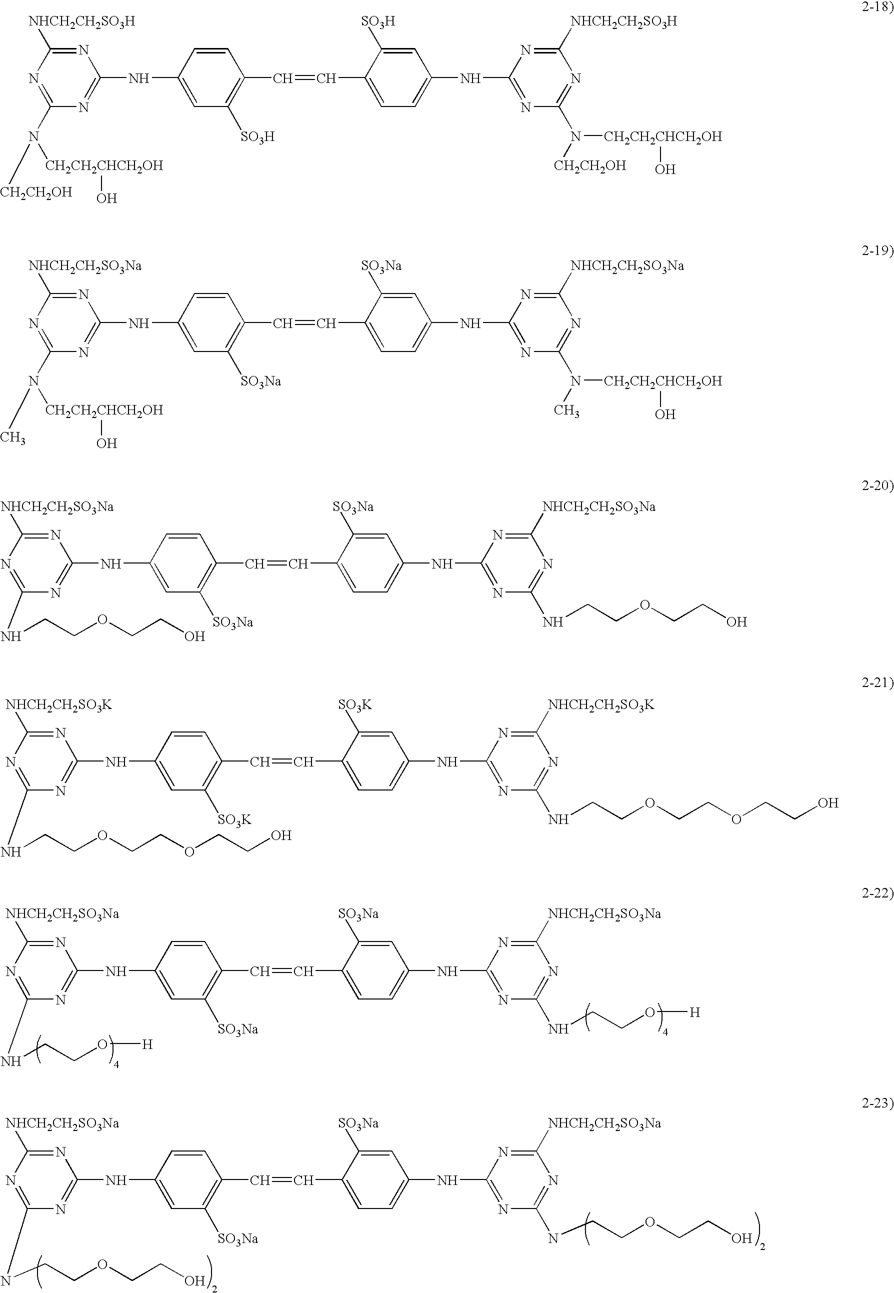

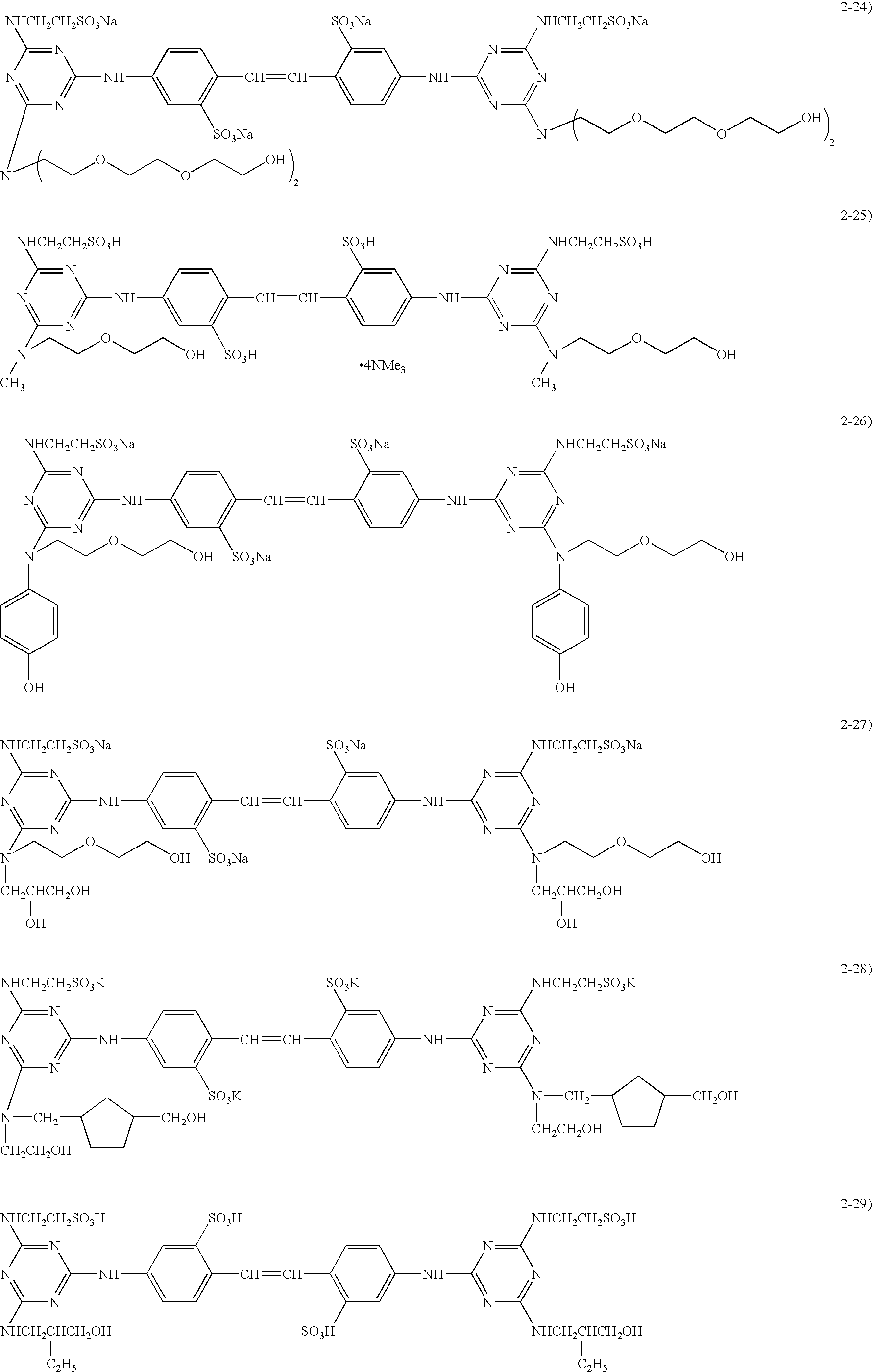

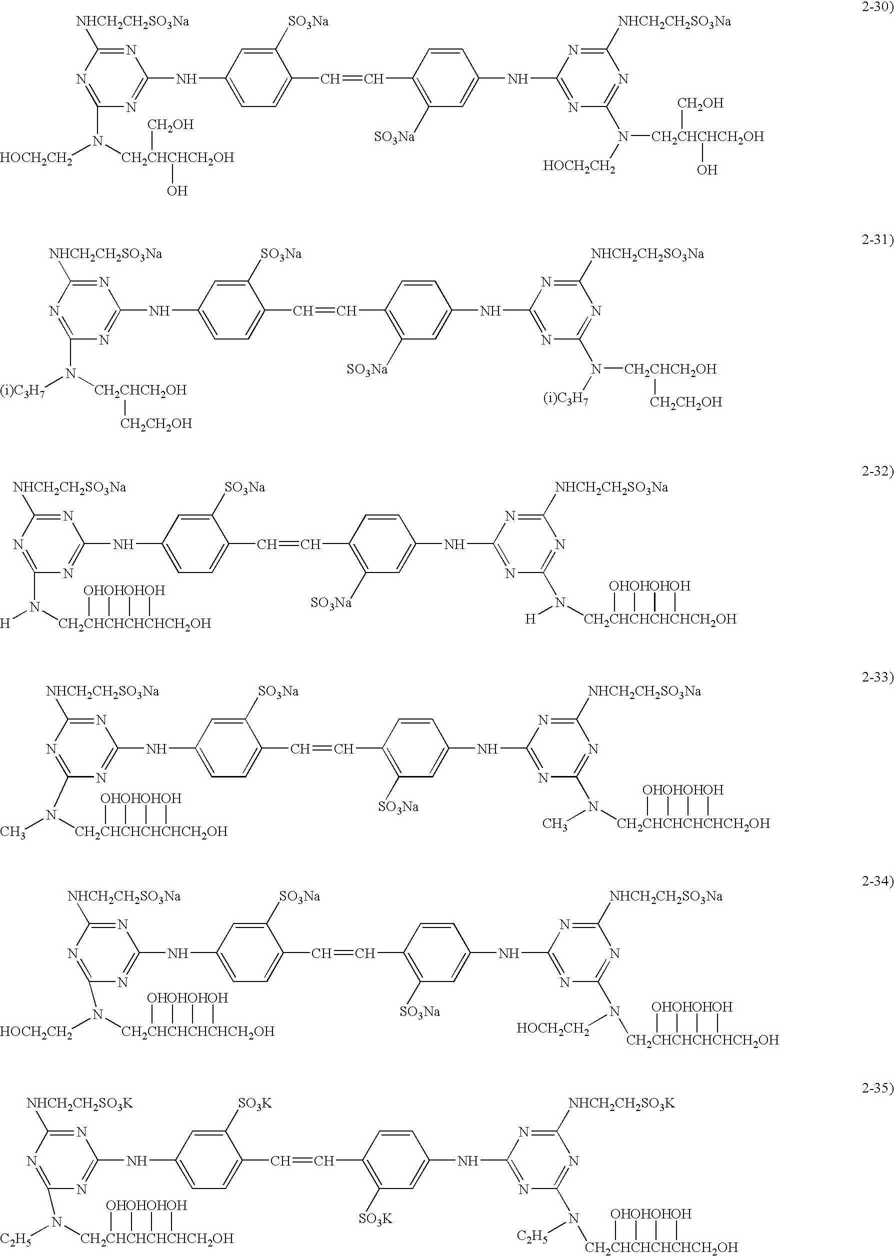

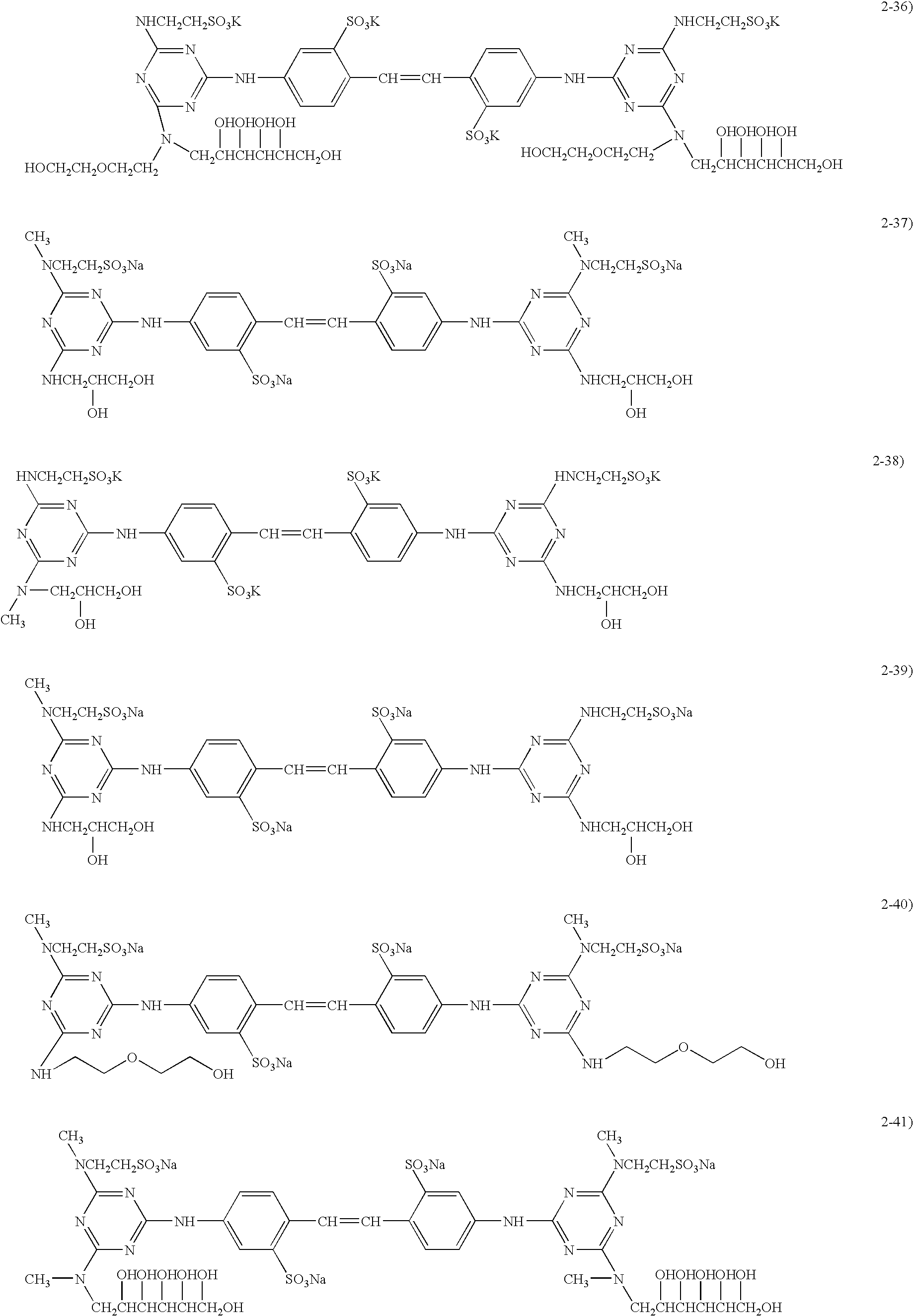

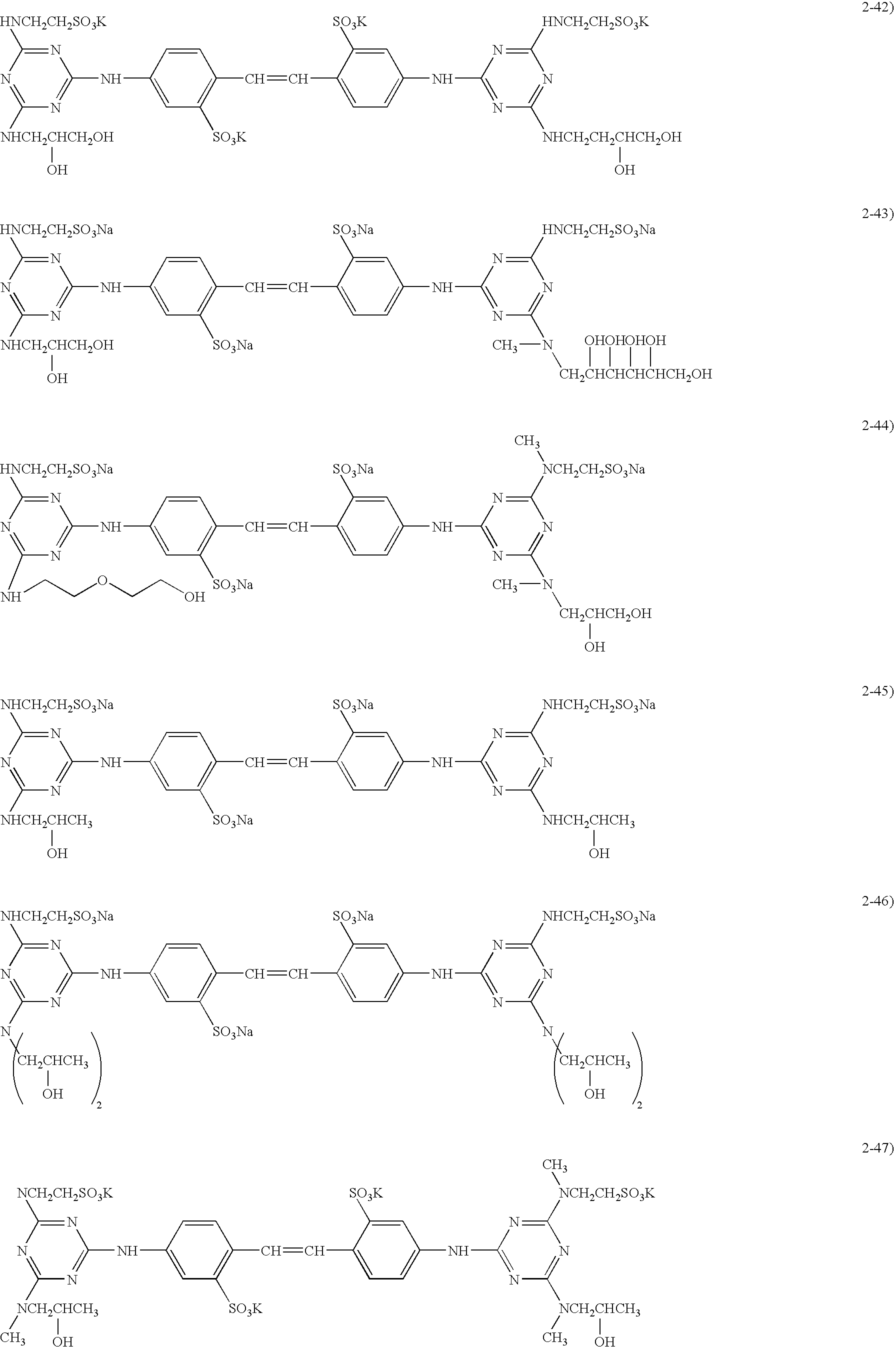

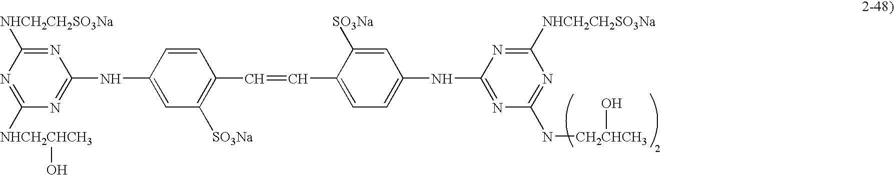

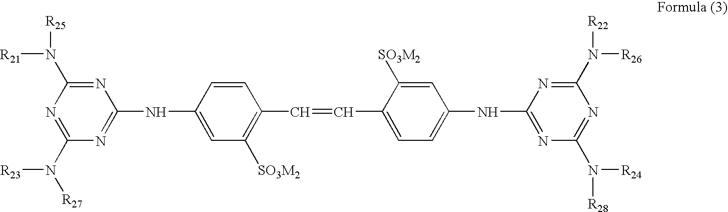

wherein R₂₁, R₂₂, R₂₃ and R₂₄ are each independently a hydrogen atom, an alkyl group or an aryl group; R₂₅ and R₂₆ are each independently an alkyl group having at least one asymmetric carbon atom, or a group represented by following Formula (3-a); R₂₇ and R₂₈ are each independently an alkyl group at least one asymmetric carbon atom; M2 is a hydrogen atom, an alkali metal atom, an alkaline-earth metal atom, an ammonium group or a pyridinium group; while R21 and R25, R22 and R26, R23 and R27, as well as R24 and R28 may combine with each other to form a ring.

—(CH₂CH₂O)ₙ₂₁H Formula (3-a)

Wherein n₂₁ is an integer of 2-4.

Preferable specific examples of the compounds represented by Formula (3) are listed below.

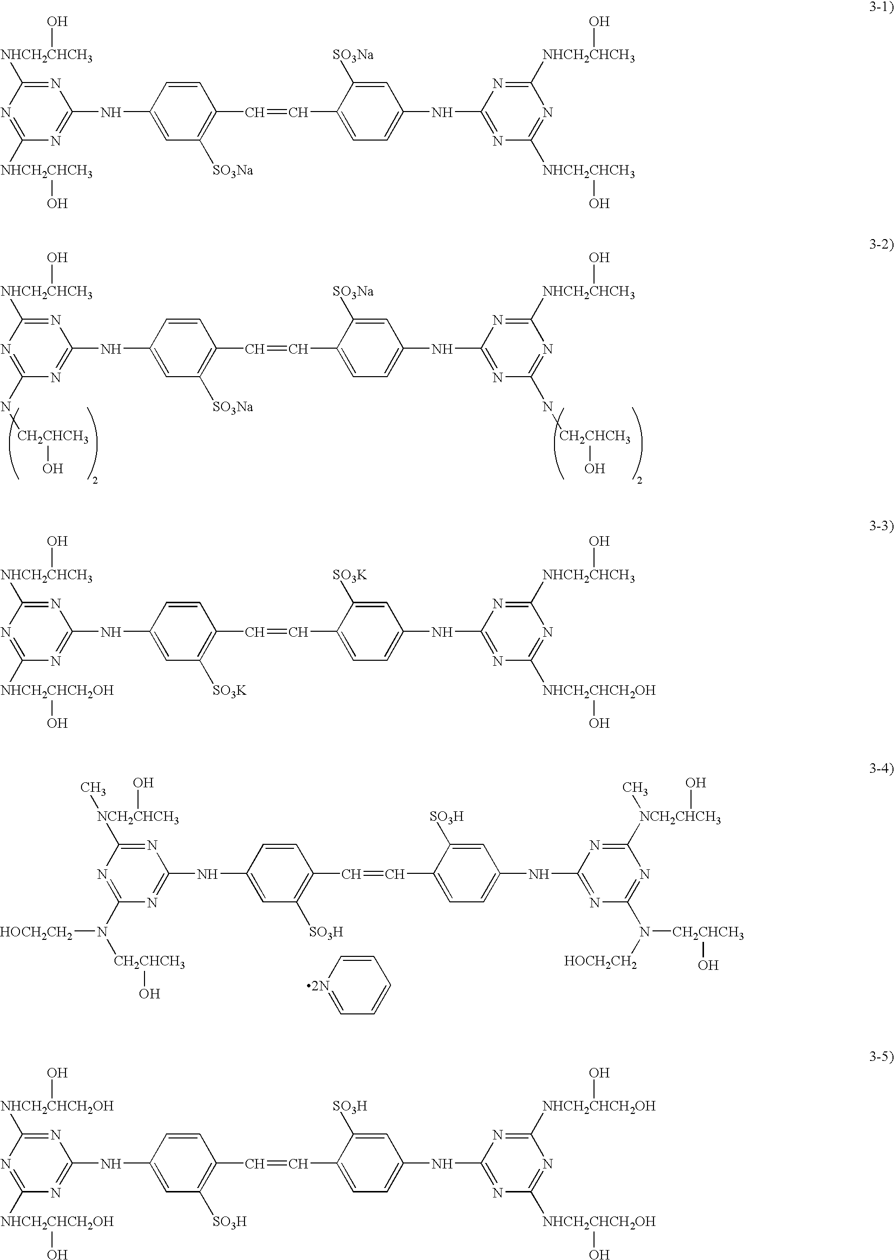

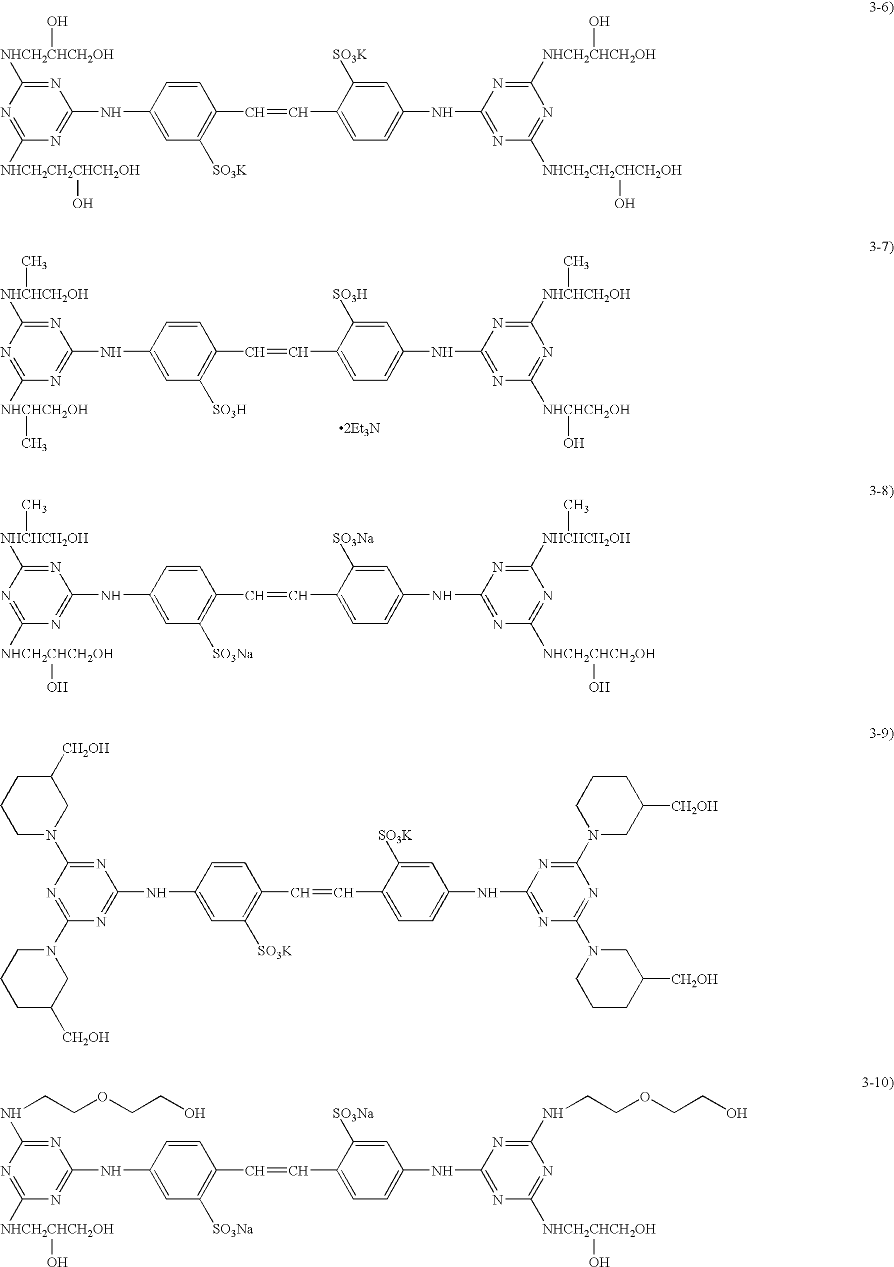

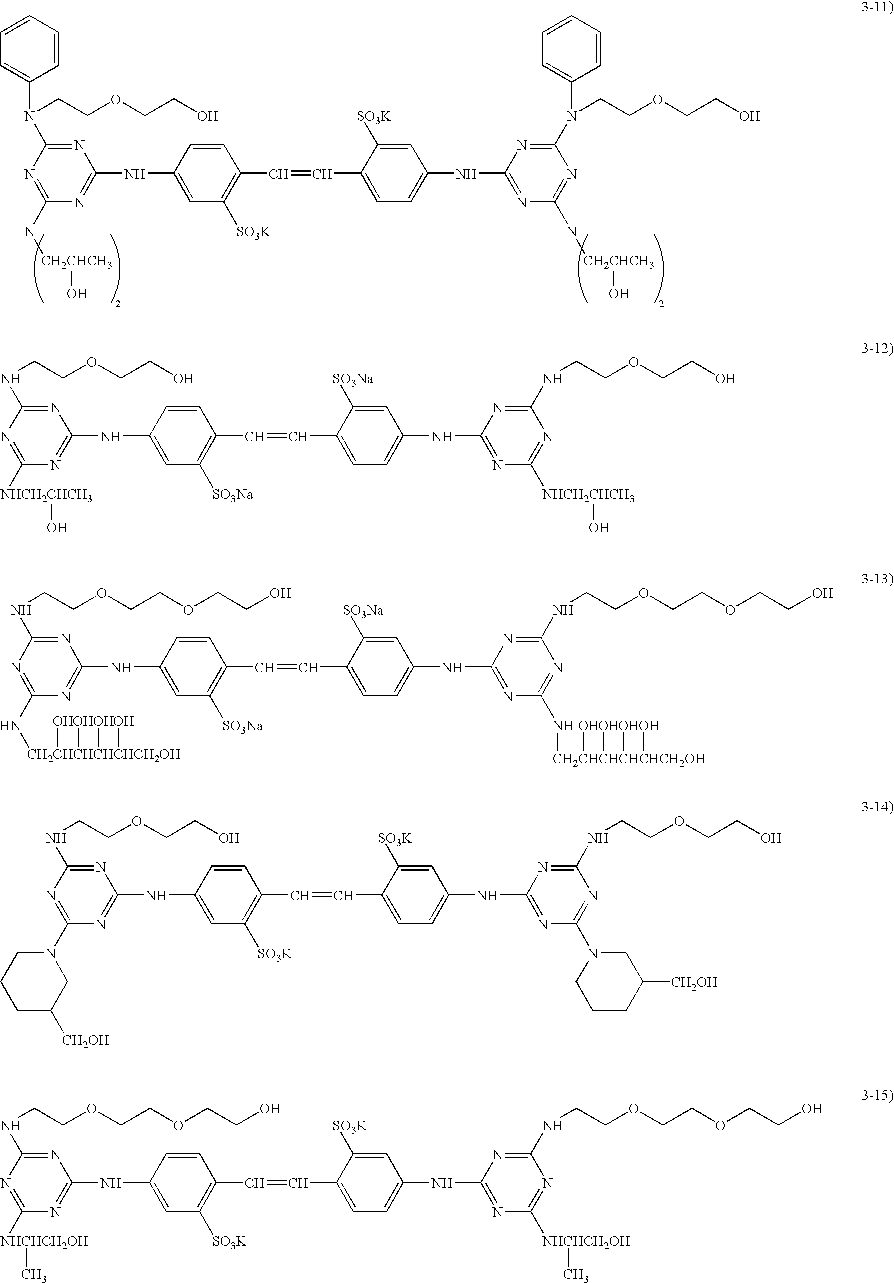

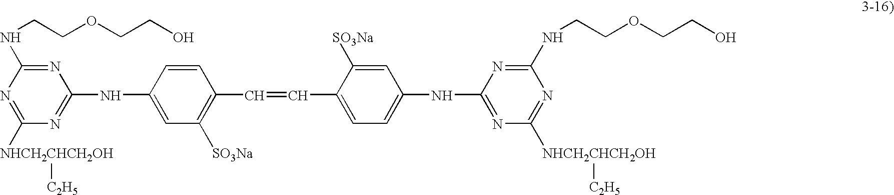

The added amount of these compounds is preferably 1×10⁻⁴-5×10⁻² mol/l, and more preferably 2×10⁻⁴-1×10⁻².

Next, the bleach-fixing process of this invention will be described.

The temperature of the bleach-fixing process is 20-70° C., but preferably 25-60° C. The replenishing amount is to be not more than 100 ml per m² of the silver halide photographic light sensitive material, but preferably 20-60. The less the replenishing amount, the more preferable from the viewpoint of reducing waste solution volume and ecological considerations. In cases when the photosensitive material is color paper, the bleach-fixing time is usually 5-60 sec., preferably 5-35 sec., and more preferably 8-25 sec.

The cross-over time from the color development tank to the bleach-fixing tank is preferably not more than 5 sec., but more preferably not more than 3 sec. In cases when the cross-over time is less than 3 sec., a marked reduction of bleach fogging results.

Further, the process of the bleach-fixing processing may take various forms as described below.

Specific bleach-fixing processes are listed below.

(Process 1) Bleach-fixing

(Process 2) Bleaching-Bleach-fixing

(Process 3) Bleaching-Bleach-fixing-Fixing

(Process 4) Fixing-Bleach-fixing

(Process 5) Bleach-fixing-Fixing

Each of the bleaching, bleach-fixing and fixing steps may optionally be divided into plural baths or a cascade system may be applicable.

Next, a rinsing or stabilizing solution, and a rinsing or stabilizing process will be described.

The pH value of the rinsing or stabilizing solution is preferably in the range of 4.0-10.0. Agents to adjust pH to the foregoing value may also be incorporated. As pH adjusting agents, any of the generally known alkaline chemicals or acid chemicals may be employed.

In the rinsing or stabilizing solution of this invention, appropriately employed are components usually incorporated in the stabilizer such as a chelating agent (e.g., ethylenediaminetetraacetic acid, diethylenetriaminepentaacetic acid, or 1-hydroxyethylidene-1,1-disulfonic acid); a buffering agent (e.g., potassium carbonate, a borate, an acetate, or a phosphate); a fungicide (e.g., Diacide 702, produced by Grace Dearborn Co., Ltd., U.S.A., p-chloro-m-cresole, or benzoisothiazoline-3-one); a fluorescent brightening agent (e.g., a triazinylstilbene type compound); an antioxidant (e.g., an ascorbic acid salt); a water soluble metal salt (e.g., a zinc salt or a magnesium salt).

Further, to the rinse or the stabilizing solution, to enhance solution stability, it is preferred that a sulfinate, a sulfite, a bisulfite or a metabisulfite is contained. Any organic or inorganic compound which releases a sulfite ion may be employed, but preferably employed is an inorganic salt.

As preferable specific examples, listed are sodium sulfite, potassium sulfite, ammonium sulfite, ammonium bisulfite, potassium bisulfite, sodium metabisulfite, potassium metabisulfite, and ammonium metabisulfite. These salts are preferably added to the stabilizing solution at least in the amount of 1×10⁻³ mol/l, and more preferably 5×10⁻³-5×10⁻² mol/l. The replenishing amount of the rinse or the stabilizing solution is not to be more than 180 ml per m² of the photosensitive material to be processed, and preferably not more than 120 ml.

The processing temperature of the rinse or the stabilizing solution is preferably 20-70° C., and more preferably 25-60° C. After the rinse or the stabilizing solution processing, no further washing processing is needed, but surface washing using a little amount of water for an extremely short time may be optionally conducted according to need.

Next, the color development solution and the step of color development processing applicable to this invention will be described.

Typical examples of the color developing agents usable for the color development solution are shown below, but are not limited to these examples.

(C-1) N,N-diethyl-p-phenylenediamine

(C-2) 4-amino-N,N-diethyl-3-methylaniline

(C-3) 4-amino-N-(β-hydroxyethyl)-N-methylaniline

(C-4) 4-amino-N-ethyl-N-(β-hydroxyethyl)aniline

(C-5) 4-amino-N-ethyl-N-(-hydroxyethyl)-3-methylaniline

(C-6) 4-amino-N-ethyl-N-(3-hydroxypropyl)-3-methylaniline

(C-7) 4-amino-N-ethyl-N-(3-hydroxybutyl)-3-methylaniline

(C-8) 4-amino-N-ethyl-N-(β-methanesulfonamidoethyl)-methylaniline

(C-9) 4-amino-N,N-diethyl-3-(β-methoxyethyl)-3-methyl-aniline

(C-10) 4-amino-N-ethyl-N-(-methoxyethyl)-3-methylaniline

(C-11) 4-amino-N-(-ethoxyethyl)-N-ethyl-3-methylaniline

(C-12) 4-amino-N-(3-carbamoylpropyl)-N-n-propyl-3-methyl-aniline

(C-13) 4-amino-N-(4-carbamoylbutyl)-N-n-propyl-3-methyl-aniline.

Of the foregoing p-phenylenediamine derivatives, preferred color developing agents are compounds (C-6), (C-7), (C-8), and (C-12), and specifically preferred is compound (C-8).

The salt of the foregoing p-phenylenediamine derivatives with a sulfate, hydrochloride, sulfite, naphthalenedisulfonic acid or p-toluenesulfonic acid may be employed. The amount of the used aromatic primary amine color developing agent is preferably 0.002-0.2 mol per liter of the development solution (being a tank solution), and is more preferably 0.005-0.1 mol.

In the practice of this invention, it is preferred to use a development solution which contains substantially no benzyl alcohol. The term “contains substantially no” here means that the content of benzyl alcohol is preferably not more than 2 ml/l, more preferably not more than 0.5 ml/l, and still more preferably, no benzyl alcohol is contained. The development solution and the replenisher usable in this invention more preferably contain substantially no sulfite ions.

The sulfite ion exhibits the function of a preservative of the developing agent, and at the same time it has effects to lower the dye forming efficiency by silver halide solvent action, and reacts with oxidants of the developing agent. It is assumed that these actions may be one of the causes to increase fluctuation of photographic characteristics during continuous processing. The term “substantially contains no” here means that the content of the sulfite ions is preferably not more than 0.1 mol per mol of the developing agent, and the most preferred is that no sulfite ions are contained. However, in this invention, a rather small amount of the sulfite ions used for anti-oxidation of the concentrated processing composition of the developing agent, before preparation of the working solution, is an exception.

The development solution of this invention preferably contains substantially no sulfite ions, and further, more preferably contains substantially no hydroxylamine. This means that content variation of hydroxylamine is assumed to affect photographic characteristics, because hydroxylamine exhibits a function as a preservative of the development solution, and at the same time is capable of silver developing. The expression “contains substantially no hydroxylamine” means that the content of hydroxylamine is preferably not more than 5.0×10⁻³ mol/l, and most preferably contains no hydroxylamine. The development solution used in this invention more preferably contains an organic preservative instead of the foregoing hydroxylamine and sulfite ions. “Organic preservatives” indicates overall organic compounds which decrease the deterioration rate of the aromatic primary amine color developing agent by being added to the processing solution of the color photosensitive materials.

Namely, it means organic compounds which exhibit the a prevention capability of the oxidation function of the color developing agent by air. Of these, specifically effective organic priservatives are hydroxylamine derivatives (being eliminated hydroxylamine, and the same in the following), hydroxamic acids, hydrazines, hydrazides, phenols, α-hydroxyketones, α-aminoketones, saccharoses, monoamines, diamines, polyamines, quaternary ammonium salts, nitroxy radicals, alcohols, oximes, diamide compounds, and condensed ring amines. These compounds are disclosed in JP-A Nos. 63-4235, 63-30845, 63-21647, 63-44655, 63-53551, 63-43140, 63-56654, 63-58346, 63-43138, 63-146041, 63-44657, 63-44656, U.S. Pat. Nos. 3,615,503, 2,494,903, and JP-A 52-143020, and Examined Japanese Patent Publication (hereinafter, referred to as JP-B) 48-30496.

Preservatives other than these, various metals described in JP-A Nos. 57-44148 and 57-53749, salicylic acids described in JP-A 59-180588, alkanolamines described in JP-A 54-3532, polyethyleneimines described in JP-A 56-94349, as well as aromatic polyhydroxy compounds described in U.S. Pat. No. 3,746,544 may be contained based on need. Specifically, preferred is addition of alkanolamines such as triethanolamine, dialkylhydroxylamines such as diethylhydroxylamine, hydrazine derivatives or aromatic polyhydroxy compounds.

Of the foregoing organic preservatives, specifically preferred are hydroxylamine derivatives and hydrazine derivatives (being hydrazines and hydrazides), details of which are described in JP-A Nos. 1-97953, 1-186939, 1-186940, and 1-187557. Further, it is preferable that the foregoing hydroxylamine derivatives or hydrazine derivatives are combined with the amines for enhancement of stability of the color development solution, and consequently, for enhancement of stability during continuous processing.

As foregoing amines, listed are cyclic amines as described in JP-A 63-239447, amines described in JP-A 63-128340, and other amines described in JP-A Nos. 1-186939 and 1-187557. Further, in this invention, hydroxylamine derivatives represented by Formula (D) are preferably employed.

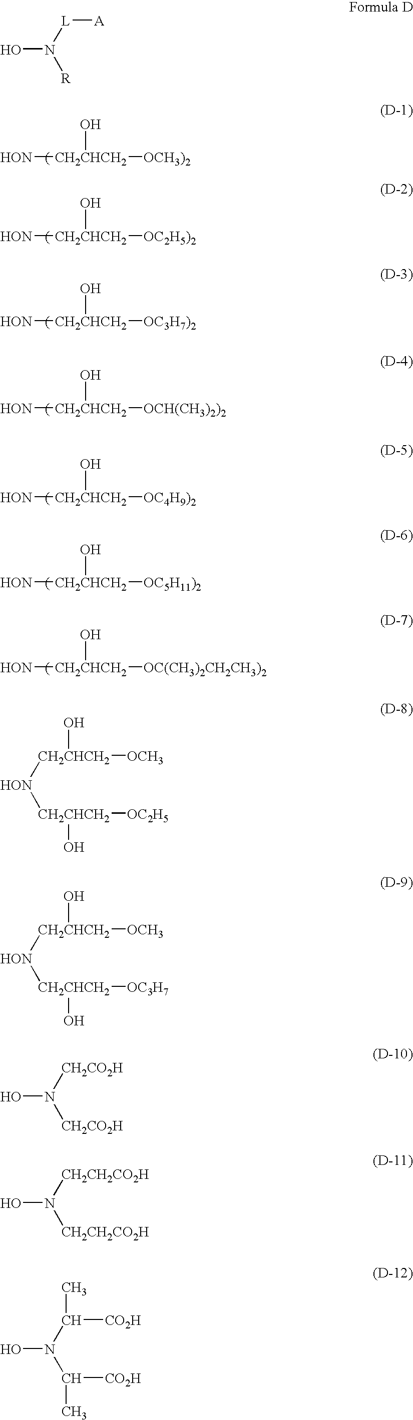

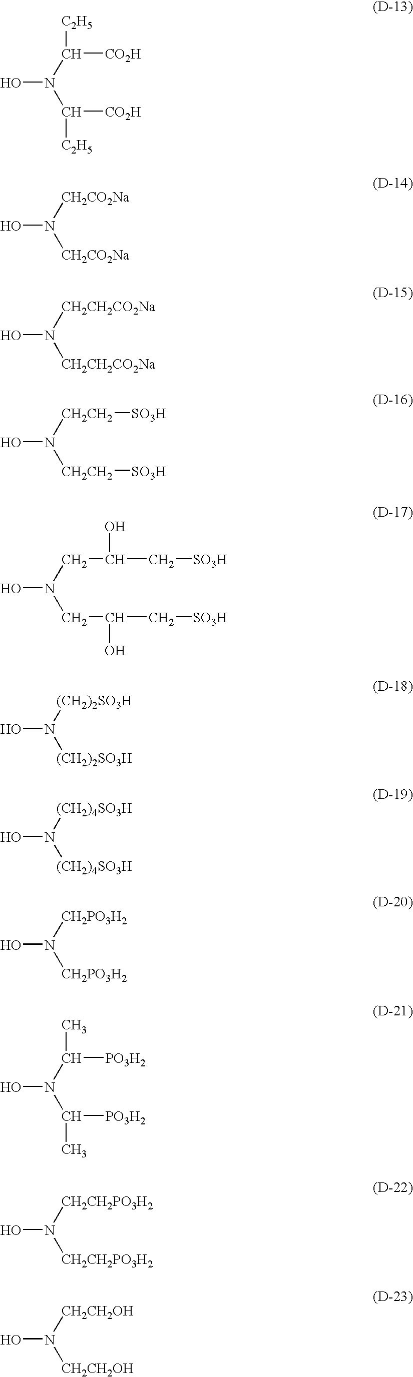

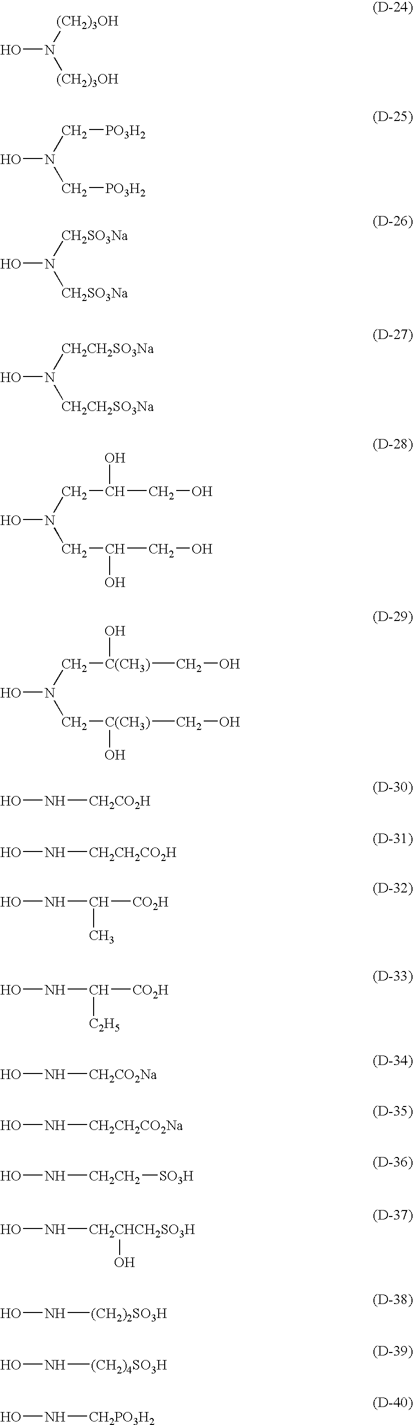

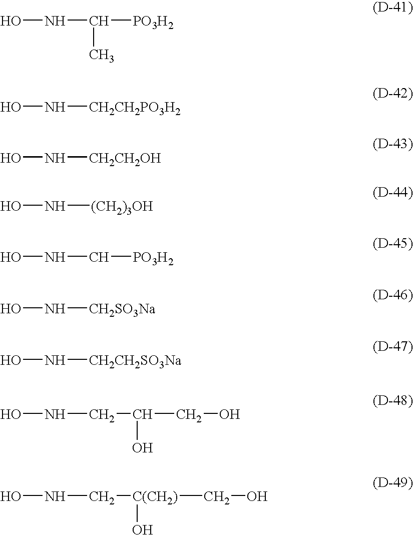

wherein L is an alkylene group which may be substituted; A is a carboxyl group, a sulfo group, a phosphone group, a phosphine group, a hydroxyl group, an amino group which may be substituted with an alkyl group, an ammonio group which may be substituted with an alkyl group, a carbamoyl group which may be substituted with an alkyl group, a sulfamoyl group which may be substituted with an alkyl group, or an alkylsulfonyl group which may be substituted; and R is a hydrogen atom or an alkyl group which may be substituted. The foregoing compounds are employed alone or in combination of more than two. Further, the added amount is typically 0.001-1.0 mol/l, but preferably is 0.002-0.2 mol/l.

The development solution used in this invention preferably exhibits a pH value of 9.0-12.0. The color development solution may contain other well-known compounds of development solution components.

To maintain the foregoing pH, it is preferred to employ various buffering agents. As buffering agents, employable are carbonates, phosphates, borates, tetraborates, hydroxybenzoates, glycyl salts, N,N-dimethylglycine salts, leucine salts, norleucine salts, guanine salts, 3,4-dihydroxyphenylalanine salts, alanine salts, aminobutylates, 2-amino-2-methyl-1,3-propanediolates, valine salts, proline salts, trishydroxyaminomethane salts, and lycine salts. Specifically, carbonates, phosphates, tetraborates, and hydroxybenzoates are superior in solubility, and buffering ability in the high pH region such as a pH higher than 9.0, and exhibit no adverse effects (such as fogging) of photographic characteristics when added to the color development solution, as well as having the advantage of a moderate price. Therefore, it is specifically preferred to employ these buffering agents.

Specific examples of these buffering agents include sodium carbonate, potassium carbonate, sodium bicarbonate, potassium bicarbonate, trisodium phosphate, tripotassium phosphate, disodium phosphate, dipotassium phosphate, sodium borate, potassium borate, sodium tetraborate (being borax), potassium tetraborate, sodium 0-hydroxybenzoate (being sodium salicylate), potassium 0-hydroxybenzoate, sodium 5-sulfo-2-hydroxybenzoate (being sodium 5-sulfosalicylate), and potassium 5-sulfo-2-hydroxybenzoate (being potassium 5-sulfosalicylate). However, the present invention is not limited to these compounds.

The added amount of the buffering agents to the color development solution and the replenisher is preferably at least 0.1 mol/l, and specifically preferably 0.1-0.4 mol/l. The color development solution may contain other ingredients, such as various kinds of chelating agents, which function to prevent precipitation of calcium or magnesium or enhance stability of the color development solution. Examples of chelating agents include nitrilotriacetic acid, diethylenetriaminepentaacetic acid, ethylenediaminetetraacetic acid, N,N, N-trimethylenephosphonic acid, ethylenediamine-N,N,N′,N′-tetramethylenesulfonic acid, trans-silohexanediaminetetraacetic acid, 1,2-diaminopropanetetraacetic acid, glycol-ether-diaminetetraacetic acid, ethylenediamine-orthohydroxyphenylacetic acid, 2-phosphonobutane-1,2,4-tricarboxylic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid.

These chelating agents may optionally be used in combination. A chelating agent is used in an amount sufficient for sequestering metal ions contained in the color development solution, for example, about 0.1-10 g per liter.

The color development solution may optionally be added with a development accelerator. Optionally added may be development accelerators including, for example, commonly known thioether compounds as described in JP-B Nos. 37-16088, 37-5987, 38-7826, 44-12380, and 45-9019, and U.S. Pat. No. 3,813,247, p-phenylenediamine type compounds described in JP-A Nos. 52-49829 and 50-15554, quaternary ammonium salt compounds described in JP-A 50-137726, JP-B 44-30074, JP-A Nos. 56-156826 and 52-43429, amine type compounds described in U.S. Pat. Nos. 2,494,903, 3,128,182, 4,230,796, and 3,253,919, and JP-B 41-11431, and U.S. Pat. Nos. 2,482,546, 2,596,926 and 3,582,346, polyalkyleneoxides described in JP-B Nos. 37-16088 and 42-25201, and U.S. Pat. No. 3,128,183, and. JP-B Nos. 41-11431 and 42-23883, and U.S. Pat. No. 3,532,501, 1-phenyl-3-pyrazolidones, imidazole compounds and ascorbic acid.

The color development solution may optionally contain antifogging agents, based on need. As antifogging agents, usable are alkali metal halides such as sodium chloride, potassium bromide, and potassium iodide, and organic antifogging agents. As organic antifogging agents, listed are nitrogen-containing heterocyclic compounds, for example, benzotriazole, 6-nitrobenzimidazole, 5-nitroisoindazole, 5-methylbenzotriazole, 5-nitrobenzotriazole, 5-chloro-benzotriazole, 2-thiazolyl-benzimidazole, 2-thiazolylmethyl-benzimidazole, indazole, and hydroxyazaindolidine and adenine.

To the development solution applicable to this invention, it is preferable that the compounds represented by foregoing Formulas (1)-(3) or fluorescent brightening agents are incorporated from the viewpoint of enhancing the white background of prints. As fluorescent brightening agents, preferred are 4,4′-diamino-2,2′-disulfostilbene type compounds. The added amount is generally 0-5 g/l, and preferably 0.1-4 g/l. Further, added may be various well-known water-soluble polymers such as a polyvinyl alcohol, polyacrylic acid, polystyrene sulfonic acid, polyacrylamide, polyvinylpyrrolidone, and their copolymer, or various surface active agents such as an alkylsulfonic acide, arylsulfonic acid, aliphatic carboxylic acid, and aromatic carboxylic acid polyethylene oxide.

The color development replenisher solution of this invention preferably contains a chloride at 4.0×10⁻²-3.0×10⁻¹ mol/l, exhibiting the advantage of reduced processing fluctuation in a low replenishing system or in a quick processing system.

The preferable replenishing amount of the color development solution of this invention is usually not more than 120 ml/m², and more preferably 20-100 ml/m².

The temperature of the color development solution applicable to this invention is usually 20-50° C., and preferably 30-45° C. The processing time is usually 5-100 sec., and preferably 10-30 sec.

Further, the color development solution exhibits relatively superior processing properties compared to the solutions of those other than this invention, even when the exposed surface area ratio {air contact area (cm²)/solution volume (cm³)} exhibits any value. However, from the viewpoint of stability of the color development solution, the exposed surface area ratio is preferably 0-0.1 cm⁻¹. During continuous processing, the ratio is preferably in the range of 0.001-0.05 cm⁻¹, and more preferably 0.002-0.03 cm⁻¹.

As methods to decrease the exposed surface area ratio, a floating lid may be provided on the surface of the photographic processing solution in the processing tank, and other than that, listed are an adjustable lid described in JP-A 62-241342, and a slit processing method described in JP-A 63-216050.

Drying processes usable in this invention will now be described. In the ultra quick processing of this invention, the drying time is required to be not more than 60 sec. to complete images, and specifically desired is 5-40 sec. As a means to reduce the drying time, from the photosensitive material point of view, a decrease of a hydrophilic binder such as gelatin, leading to decreasing the carry-in water onto the film layers, may be a means to improve. Further, from the viewpoint of decreasing carry-in water to the drying section, drying can be accelerated by absorbing water using squeezing rollers or absorbent cloth right after leaving the washing tanks. The improving means, from the drying apparatus aspect, it is typical but drying can be accelerated by raising the drying temperature and by increasing the force of the blown air. Furthermore, adjustment of the blowing angle or exhausting the forced air will accelerate drying.

The processes employed in this invention, are listed below:

(1) Color development-Bleaching-Bleach-fixing-Fixing-Stabilizing

(2) Color development-Bleaching-Bleach-fixing-Fixing-First stabilizing-Second stabilizing

(3) Color development-Bleach-fixing-Stabilizing

As silver halide particles in the photosensitive material, employed are silver halide particles, being mainly silver chloride which contain silver chloride of at least 90 mol %, preferably at least 95 mol %, more preferably 98 mol %, and still more preferably 99 mol %.

The silver coverage of the photosensitive material used in this invention is preferably less than 0.70 g/m² to optimize the desired effects of this invention. The foregoing silver halide emulsion, of mainly silver chloride, may contain silver bromide and/or silver iodide as silver halide compositions other than silver chloride. In that case, silver bromide is preferably less than 10 mol %, more preferably less than 5 mol %, and still more preferably less than 2 mol %. In cases when silver iodide is incorporated, it is preferably to be less than 1 mol %, more preferably less than 0.5 mol %, and is still more preferably none.

Such silver halide particles, being mainly silver chloride, comprise silver chloride of at least 90 mol %, may be applied to at least one of the silver halide emulsion layers, however, preferred is to be applied to the all light sensitive silver halide emulsion layers.

The crystal of the foregoing silver halide particles may be a regular crystal, a twin crystal or other crystal shapes, and a ratio of a (1, 0, 0) surface to a (1, 1, 1) surface is optionally employed. Further, crystal structures of these silver halide particles may be acceptable even if uniform from interior to outside, or interior and exterior being different layer structures or phase structures (such as a core-shell type). Further, these silver halides may be either one which forms latent images mainly on the surface or on the interior of the particles. Further, tabular silver halide particles (please refer to JP-A Nos. 58-113934 and 61-47959) may be employed. Still further, employed may also be silver halides described in JP-A Nos. 64-26837, 64-26838 and 64-77047.

The foregoing silver halide particles may be prepared by any method such as an acid process, a neutral process or an ammonia process.

Further, also employed may be a method in which seed particles are prepared by an acid process and further growth is promoted by an ammonia process at a higher rate to the certain size. The pH and pAg in the reaction vessel may be controlled during growth of silver halide particles, after which it is preferred to sequentially or simultaneously mix the silver ions and halide ions in amounts commensurate with the growth rate of the silver halide particles, as described in JP-A 54-48521.

Next, the packaging material for the concentrated bleach-fixing composition and the starter will be described. Material used for the packaging the concentrated bleach-fixing composition and/or the starter mixed with the composition of this invention may be any such as paper or plastic. The starter of this invention is preferably packaged into a material which has an oxygen transmission factor of less than 40 ml/m²·atm·day, and more preferably less than 20 ml/m²·atm·day. Here, the oxygen transmission factor is determined by the law of the art according to JIS 1707.

The preferably used materials for packaging of this invention are plastics, examples of which are listed below, but are not limited to these examples.

A. polyolefin type resin

B. ethylene-vinyl acetate copolymer type resin

C. ethylene-vinyl alcohol copolymer type resin

D. polyamide type resin

E. ceramics

F. acrylonitrile type resin

G. polyethylene terephthalate type resin

H. polyvinilidene halide type resin

I. polyvinyl halide type resin

Of polyolefin type resins, polyethylene is preferred and any of the low density polyethylenes (hereinafter, referred to as LDPE), medium density polyethylenes (MDPE) and high density polyethylenes (HDPE) is usable in this invention, however HDPE is preferably employed, at a density range of 0.941-0.969. The preferred LDPE can be synthesized through high pressure polymerization, and is preferred to be at a density range of 0.910-0.925.

HDPE of the foregoing density range is preferred for containers in this invention, and especially one at a melt index of 0.3-7.0 g/10 min. (which is determined at an extrusion pressure of 2.16 kg and a temperature of 190° C., as defined in ASTM D1238), but more preferably 0.3-5.0 g/10 min. HDPE falling within the foregoing range is stable as a container of the concentrated bleach-fixing composition. The wall thickness of a container depends on the material, but is preferably 0.1-2.0 mm, more preferably 0.3-1.5 mm, and still more preferably 0.4-1.0 mm.

Of polyamide type resins, nylon is preferred in terms of puncture resistance and pinhole resistance. The thickness thereof is preferably 3-50 μm, and more preferably 5-30 μm. Stretched nylon is specifically preferred. Ceramics are inorganic materials which are mainly comprised of silicon oxide, and may be coated in vacuo with polyethylene or polyethylene terephthalate. Specific examples thereof include GL type (ceramic deposited film, available from Toppan Printing Co. Ltd.).

Examples of ethylene-vinyl alcohol copolymer resins include Kuraray EVERL Film (EF-XL, EF-F, EF-E, available from Kuraray Co., Ltd.). Halogens of polyvinylidene halide type resins and polyvinyl halide type resins are, for example, chlorine, fluorine and bromine. Specific examples include polyvinylidene chloride, polyvinylidene fluoride, and polyvinyl fluoride. However, generation of toxic gas during incineration is a concern, so that of the foregoing resin groups, A-G are preferable in the invention and specifically preferable are A-F.

The resins usable in this invention can be selected from resins satisfying the above preferable conditions. These resins are described in “Plastic Film” (Gisaku Takahashi, published by The Nikkan Kogyo Shimbun, Ltd., Dec. 20, 1976, expanded edition).

These materials may be molded as single compositions or at least two kinds of materials may be laminated in film form and used as a multi-layer film. The container may be formed into any reasonable shape, including a bottle type and a pillow 4type. In cases when using a multi-layer film for the container, the layer arrangement thereof are, for example, as follows:

(1) LLDPE (linear low density polyethylene)/Ny (nylon)/PET (polyethyleneterephthalate)

(2) LLDPE/Ny/EVOH (EVERL)/Ny/ONy (stretched nylon)

(3) LLDPE/EVA (ethylene-vinyl acetate copolymer)/Ny

(4) LLDPE/S•PE (sand polyethylene)/HDPE (high density polyethylene)/Ny/EVOH/Ny/PET

(5) LLDPE/KOH (vinylidene chloride coated nylon)

(6) LLDPE/GLPET (ceramic coating polyethyleneterephthalate)

(7) PE (polyethylene)/EVOH/OPP (stretched polypropylene)

(8) LDPE (low density polyethylene)/EVOH/PET

(9) LDPE/EVOH/ONy

(10) PE/KPE (vinylidene chloride polyethylene polyester)

(11) PE/Ny

(12) PE/EVOH/Ny

(13) PE/EVOH/KPE

(14) PE/EVOH/KPET (vinylidene chloride coated PET)

(15) LDPE/EVOH/KPET

(16) EVA (polyethylene-vinyl acetate copolymer)/Ny

(17) EVA/ONy

(18) EVA/EVOH/ONy

(19) LDPE/AN (acrylonitrile)

(20) LLDPE/S•PE/LLDPE/Ny/EVOH/Ny/ONy

(21) LLDPE/S•PE/HDPE/S•PE/LLDPE/Ny/EVOH/Ny/PET

(22) LLDPE/S•PE/LLDPE/Ny/EVOH/Ny/ONy

(23) LLDPE/S•PE/LLDPE/Ny/EVOH/Ny/PET

Methods for preparing multi-layer film are not specifically limited, but include the methods to: laminate film to film using an adhesive agent; laminate film via a fused resin; extrude two or more resins from slits for so-called co-extrusion; and any generally used film lamination method may be employed alone or in combination.

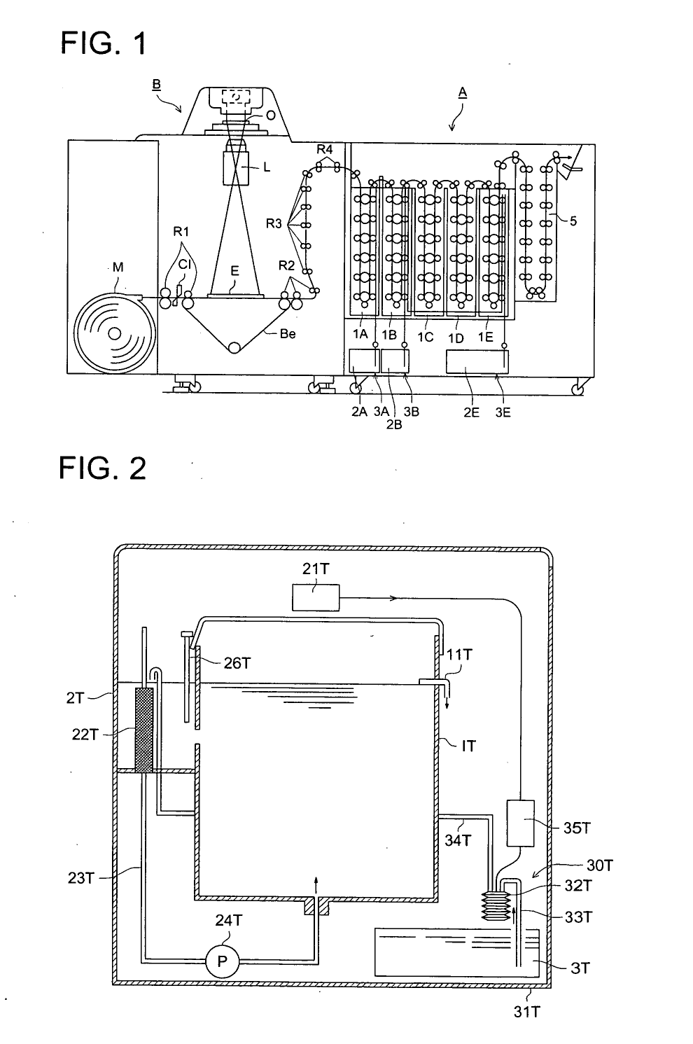

Next, an example of a preferably employed automated developing processor (hereinafter, simply referred to as an automated processor) in this invention will be described based on accompanying drawings. This automated processor is a modified NPS 808, manufactured by Konica Corp. FIG. 1 is a schematic block diagram of a processing apparatus of a photosensitive material (a so-called printer-processor), integrating automated processor A and photographic printer B.

In FIG. 1, at the lower-left portion of photographic printer B, placed is magazine M containing a roll of unexposed photographic print paper (so-called color paper). Color paper drawn from the magazine is cut to a predetermined size to be a sheet of color paper fed through rollers R1 and cutter section C1. This sheet of paper is transported by belt transportation means Be, and original image O is exposed at exposure section E via a light source and lens L. The exposed sheet of paper is further transported through a plurality of paired rollers R2, R3 and R4, introducing the paper into automated processor A. In automated processor A, the sheet of paper is sequentially transported through each of several processing tanks 1, being color development tank 1A, bleach-fixing tank 1B and stabilizing tanks (1^{st} stabilizing tank 1C, 2^{nd} stabilizing tank 1D and 3^{rd} stabilizing tank 1E, being a 3 tank configuration) by roller transportation means (no designation) for color development, bleach-fixing and stabilizing process. The sheet of paper processed through each foregoing process, is dried in drying section 5, and then discharged from the apparatus.

The solid line in the figure from magazine M to drying section 5 indicates the transportation route of the photosensitive material. In this example, a photosensitive material is introduced into automated processor A in a cut sheet state. Meanwhile, color paper may be introduced into automated processor A in the form of a strip. In that case, processing effectiveness can be enhanced when an accumulator which temporarily retains the photosensitive material, is provided between automated processor A and photographic printer B.

Further, it is obvious that automated processor A, preferably used in this invention, may be integrated with photographic printer B, or may be used alone.

The photosensitive material processable in automated processor A is not limited to exposed color paper, and can of course also be used to process negative film.

To each processing tank of color development tank 1A, bleach-fixing tank 1B and 3^{rd} stabilizing tank 1E, replenisher supply means 3A, 3B and 3E are respectively provided to supply appropriate replenisher solutions. Further, also provided are external replenisher tanks 2A, 2B and 2E for storing each replenisher.

A circulation system, as for example shown in FIG. 2, comprises circulation pipe 23T, circulation pump 24T, processing tank 1T and auxiliary tank 2T, forming a closed re-circulation route for the solution. One end of circulation pipe 23T is connected to the ejection side of the foregoing circulation pump 24T and penetrates the lower wall of the processing tank, and is thereby connected to processing tank 1T. With this configuration, when circulation pump 24T is activated, the processing solution is drawn from auxiliary tank 2T and ejected into the processing tank, to be mixed with the existing processing solution in the processing tank, and which then again is fed into auxiliary tank 2T for continued circulation. In this invention, the circulation direction of the processing solution is not limited to the direction shown in FIG. 2, and may be in the opposite direction. Drain pipe 11T is provided to keep the solution level constant in processing tank 1T, as well as minimizing any increase of accumulated components which are carried in by residual photosensitive material from other processing tanks or transferred from the photosensitive material.

Bar heater 26T is immersed in the processing solution in auxiliary tank 2T, penetrating the upper tank wall of auxiliary tank 2T. Heater 26T heats the processing solution in processing tank 1T based on the temperature detected by the thermometer, not shown in the figure. In other words, this system is a temperature controlling means to maintain the processing solution in processing tank 1T within a suitable temperature for processing (for example, being 20-55° C.).

Processing amount detecting means 21T, being a photoelectric sensor provided at the entrance in automated processor A, detects the amount of photosensitive material to be processed. This processing amount detecting means 21T comprises a plurality of detecting members on both edges of the paper path to detect the width of the color paper, as well as functioning as an element to note detecting duration. Since the transportation rate of the photosensitive material is mechanically set in advance, the processed area of the photosensitive material is calculated from the width and duration data.

In this invention, processing amount detecting means 21T may detect width and transport duration of the photosensitive material via an infrared sensor, a micro switch or an ultrasonic sensor. Further, any functional means may also be employed to detect the processing area of the photosensitive material may be employed, for example, employing a printer-processor as shown in FIG. 1, a means to detect the amount of the printed photosensitive material or the quantity of photosensitive material having a predetermined area.

Further, detection duration is before processing in this example, but can also be either after processing or during processing (while immersed in the processing solutions). In these cases, the location of processing amount detecting means 21T must be appropriately changed as necessary to detect the photosensitive material after processing or during processing.

Processing amount detecting means 21T need not be provided in every tank of 1A, 1B, 1C, 1D and 1E, and preferred is any one detecting means per automated processor A.

Replenisher supply controlling means 35T receives signals from foregoing processing amount detecting means 21T, and controls supply of the replenisher by replenisher supply means 30T.

Replenisher supply means 30T is housed in main body 101T of the photosensitive material processing apparatus. Replenisher supply means 30T comprises the replenisher tank, bellows pump 32T, solution suction pipe 33T and solution feeding pipe 34T. Replenisher 3T stored in replenisher tank 31T is drawn through solution suction pipe 33T by the suction action of bellows pump 32T, after which replenisher 3T is supplied to the upper portion of the processing solution surface of auxiliary tank 2T through solution feeding pipe 34T by the extrusion action of bellows pump 32T. The driving motor for foregoing bellows pump 32T is synchronized by replenisher supply controlling means 35T, replenishing as required. Further, in replenisher tank 31T, provided are a temperature adjusting means comprised of a heater and a temperature detecting sensor, whereby temperature adjustment is performed to maintain a predetermined temperature.

In FIGS. 22T is a filter and 26T is a bar heater.

### EXAMPLES

The present invention will be detailed with examples below, but is not limited to them.

### Example 1

Preparation of Concentrated One-Part Bleach-Fixing

Composition Kit: packaged at a volume of 1,000 ml

A concentrated one-part bleach-fixing composition was prepared, and was then packed into a hard plastic container to prepare concentrated one-part bleach-fixing package (being a kit).

Preparation of the Concentrated Bleach-fixing Composition

| Ammonium bisulfite (70 wt/wt %) | 0.58 | mol |
|---|---|---|
| Ammonium thiosulfate (58 wt/wt %) | 1.1 | mol |
| Aminopolycarboxylic acid Fe(III) complex | Described in Table 1 | |
| Aminopolycarboxylic acid Fe(II) complex | Described in Table 1 | |
| Succinic acid | 0.22 | mol |
| pH | 5.5 | |

The total volume was brought to 1 liter by addition of water, the pH of which was adjusted using an ammonia aqueous solution or 50% sulfuric acid.

Foregoing aminopolycarboxylic acid Fe(II) complex was prepared by dissolving ferrous sulfate heptahydrate and an aminopolycarboxylic acid in water and stirring.

Evaluation of Kit Storage Stability

The above Concentrated One-part Bleach-fixing Kit was stored at 50° C. for 2 months, and appearance of the solutions was observed for evaluation based on the following criteria.

A: No turbidity of the solution nor precipitates were observed.

B: Slight turbidity of the solution and few precipitates at the bottom of the container were observed.

C: Definite turbidity of the solution and precipitates at the bottom of the container were confirmed.

D: Significant precipitates were confirmed at the bottom of the container.

The results of the test are shown in Table 1.

TABLE 1

| | | Aminopolycarboxylic | | Evaluation | |
|---|---|---|---|---|---|
| | Aminopolycarboxylic | acid Fe(II) complex | | of Kit | |
| Experiment | acid Fe(III) complex | (added amount: | Fe(II) | Storage | |
| No. | (added amount: mol/l) | mol/l) | content | Stability | Remarks |
| I-1 | — | EDTA · FeNH₄(0.4) | 100% | A | Inv. |
| I-2 | EDTA · FeNH₄(0.12) | EDTA · FeNH₄(0.28) | 70% | A | Inv. |
| I-3 | EDTA · FeNH₄(0.2) | EDTA · FeNH₄(0.2) | 50% | A | Inv. |
| I-4 | EDTA · FeNH₄(0.24) | EDTA · FeNH₄(0.16) | 40% | B to C | Comp. |
| I-5 | EDTA · FeNH₄(0.28) | EDTA · FeNH₄(0.12) | 30% | C | Comp. |
| I-6 | EDTA · FeNH₄(0.32) | EDTA · FeNH₄(0.08) | 20% | D | Comp. |
| I-7 | s,s-EDDS-FeNH₄(0.2) | s,s-EDDS-FeNH₄(0.2) | 50% | A | Inv. |
| I-8 | s,s-EDDS-FeNH₄(0.24) | s,s-EDDS-FeNH₄(0.16) | 40% | B to C | Comp. |
| I-9 | DTPA-FeNH₄(0.2) | DTPA-FeNH₄(0.2) | 50% | A | Inv. |
| I-10 | DTPA-FeNH₄(0.24) | DTPA-FeNH₄(0.16) | 40% | B to C | Comp. |
| I-11 | DTPA-FeNH₄(0.28) | DTPA-FeNH₄(0.12) | 30% | C | Comp. |

Note:
Inv.: This invention
Comp.: Comparative sample
EDTA-Fe.NH₄: ammonium ethylenediaminetetraacetic acid Fe(III) complex
DTPA-Fe.NH₄: ammonium diethylenetriaminepentaacetic acid Fe(III) complex
s,s-EDDS-Fe.NH₄: ammonium ethylenediaminedisuccinic acid Fe(III) complex
s,s-EDDS-Fe.NH₄ represents an [s,s] optical isomer.

As apparent from Table 3, it was proved that even in a one-part constitution, by raising Fe(II) content in an ion salt such as an aminopolycarboxylic acid Fe(III) salt to not less than 50 mol %, the concentrated bleach-fixing composition kit exhibited superior storage stability.

### Example 2

The solutions of Experiment Nos. I-1, I-2, I-3, I-7 and I-9 which showed good kit storage stability above, were diluted by a factor of three with water, in which an oxidizing agent or a starter was added as described in Table 4 to prepare bleach-fixing processing solutions (being tank solutions), and the pH of the solutions was adjusted to 6.0 using ammonium hydroxide or 50% sulfuric acid. Next, 100 ml of each of the solutions above was poured into a beaker and stored at 50° C. for 2 weeks, while exposed to ambient air. After such storage, the status of the solution was observed for evaluation on the following criteria. The tested results are shown in Table 4. Any decrease of the solution volume by evaporation was periodically compensated for by addition of ion-exchanged water. Further, processing of the photosensitive material using the foregoing tank solutions were conducted under the following development processing conditions.

Storage Stability of Solution (Tank Solution)

A: No suspended solids were observed at the interface of the solution.

B: Slight suspended solids were observed.

C: A significant amount of suspended solids was observed at the interface of the solution.

Processing Apparatus and Photosensitive Material

Processing Apparatus

The processing apparatus of FIG. 1 used in this invention (hereinafter, referred to simply as an automated processor) are described below.

In FIG. 1, at the lower-left portion of photographic printer B, placed is magazine M containing a roll of unexposed photographic print paper (so-called color paper).

Color paper drawn from the magazine is cut to a predetermined size as a sheet of color paper fed between rollers R1 and cutter section C1. Such sheets of paper are transported by belt transportation means Be, and original image O is exposed at exposure section E via a light source and lens L. The exposed sheets of paper are further transported through a plurality of paired rollers R2, R3 and R4, introducing the sheets of paper into automated processor A. In automated processor A, the sheets of paper are sequentially transported through each of several processing tanks, being color development tank 1A, bleach-fixing tank 1B and stabilizing tanks (1^{st} stabilizing tank 1C, 2^{nd} stabilizing tank 1D and 3^{rd} stabilizing tank 1E, being a 3 tank configuration) by roller transportation means (no code designation) for color development, bleach-fixing and stabilizing processing. The sheets of paper processed through each foregoing process, are dried in drying section 5, and then discharged from the apparatus. Development processing was conducted using this automated processor.

Preparation of Multi-Layered Color Photographic Light

Sensitive Material

Preparation of Sample 101

Both sides of paper pulp having a base weight of 160 g/m2 were laminated with polyethylene to prepare a paper substrate. The side of silver halide emulsion coating side was also laminated with molten polyethylene containing a surface treated anatase type titanium oxide dispersed therein in an amount of 12 weight % to prepare the reflecting substrate. After the surface of this reflecting substrate was subjected to corona discharge, a gelatin subbing layer was provided, and then the layers comprised as in following Tables 2 and 3 were coated using a free-falling vertical curtain coating method described in JP-A 49-35447, with a coating rate of 350 m/min., to prepare multi-layered color photosensitive material of Sample 101.

Preparation of Coating Compositions

Examples of preparation of the coating compositions are described below.

Preparation of the 1^{st} Layer Coating Composition

To 23.4 g of yellow coupler (Y-1), 3.34 g of dye image stabilizing agent (ST-1), 3.34 g of dye image stabilizing agent (ST-2), 3.34 g of dye image stabilizing agent (ST-5), 0.34 g of anti-staining agent (HQ-1), 5.0 g of image stabilizing agent A, 5.0 g of a high boiling point organic solvent (DBP), and 1.67 g of a high boiling point organic solvent (DNP), 60 ml of ethyl acetate was added to be dissolved, after which the resulting solution was dispersed in 320 ml of a 7% gelatin solution containing 5 ml of a 10% surface active agent (SU-1) using an ultrasonic homogenizer, to prepare 500 ml of a yellow coupler dispersion solution. After mixing this yellow coupler dispersion solution with the blue sensitive silver halide emulsion prepared under the following conditions, a sulfosuccinic acid type surface active agent (SU-2) for coating was added to become 0.5 g per liter of the coating composition, designated as the 1^{st} layer coating composition.

Preparation of the 7^{th} Layer Coating Composition

To 2.0 g of a high boiling point organic solvent (being DBP) and 2.0 g of a high boiling point organic solvent (being DIDP), mixed was 6 ml of ethyl acetate, and dispersed into 40 ml of a 7% gelatin solution containing 2 ml of a 10% surface active agent (SU-1) using an ultrasonic homogenizer to prepare 70 ml of a dispersion solution of high boiling point organic solvents. After this dispersion solution was mixed with a 11% gelatin solution, a dispersion solution of silicon dioxide having particles of an average diameter of 2 μm was added, and further added was a sulfosuccinic acid type surface active agent (SU-2) for coating to become 2.0 g per liter of the coating composition, designated as the 7^{th} layer coating composition.

Each of the coating compositions of the other layers was prepared by adding each of the additives to obtain the coverage described in Tables 2 and 3, similar to preparation of the foregoing 1^{st} and 7^{th} layer coating compositions.

The added amount of each silver halide emulsion described in Tables 2 and 3 is shown in terms of silver. Further, F-1 was added to each layer as appropriately.

TABLE 2

| | | Added |
|---|---|---|
| | | amount |
| Layer | Composition | (g/m²) |
| 7^{th} layer | Gelatin | 0.700 |
| (protective | DBP | 0.002 |
| layer) | DIDP | 0.002 |
| wet layer | Silicon dioxide | 0.003 |
| thickness: | Surface active agent for | 0.002 |
| 7.0 μm | dispersion (SU-1) | |
| | Surface active agent for | 0.020 |
| | coating (SU-2) | |
| | Hardening agent (H-2) | 0.070 |
| 6^{th} layer | Gelatin | 0.400 |
| (UV absorbing | AI-1 | 0.010 |
| layer) | UV absorbing agent (UV-1) | 0.120 |
| wet layer | UV absorbing agent (UV-2) | 0.040 |
| thickness: | UV absorbing agent (UV-3) | 0.160 |
| 5.0 μm | Anti-staining agent (HQ-5) | 0.040 |
| | PVP | 0.030 |
| | Surface active agent for | 0.071 |
| | dispersion (SU-1) | |
| 5^{th} layer | Gelatin | 1.100 |
| (red sensitive | Red sensitive silver halide | 0.210 |
| layer) | emulsion (Em-R) | |
| wet layer | Cyan coupler (C-1) | 0.250 |
| thickness: | Cyan coupler (C-2) | 0.080 |
| 13.0 μm | Dye image stabilizing agent | 0.010 |
| | (ST-1) | 0.004 |
| | Anti-staining agent (HQ-5) | |
| | DBP | 0.100 |
| | DOP | 0.200 |
| | Surface active agent for | 0.025 |
| | dispersion (SU-1) | |
| 4^{th} layer | Gelatin | 0.900 |
| (UV absorbing | AI-1 | 0.020 |
| layer) | UV absorbing agent (UV-1) | 0.280 |
| wet layer | UV absorbing agent (UV-2) | 0.090 |
| thickness: | UV absorbing agent (UV-3) | 0.380 |
| 10.0 μm | Anti-staining agent (HQ-5) | 0.100 |
| | Surface active agent for | 0.020 |
| | dispersion (SU-1) | |
| | Hardening agent (H-1) | 0.035 |

TABLE 3

| Layer | Component | Added amount (g/m²) |
|---|---|---|
| 3^{rd} layer | Gelatin | 1.100 |
| (green sensitive | Green sensitive silver halide | 0.140 |
| layer) | emulsion (Em-G) | |
| wet layer | AI-2 | 0.010 |
| thickness: | Magenta coupler (M-1) | 0.200 |
| 14.0 μm | Dye image stabilizing agent (ST-3) | 0.200 |
| | Dye image stabilizing agent (ST-4) | 0.170 |
| | DBP | 0.130 |
| | DIDP | 0.130 |
| | Surface active agent for | 0.022 |
| | dispersion (SU-1) | |
| 2^{nd} layer | Gelatin | 1.000 |
| (inter layer) | AI-3 | 0.010 |
| wet layer | Anti-staining agent (HQ-2) | 0.030 |
| thickness: | Anti-staining agent (HQ-3) | 0.030 |
| 12.0 μm | Anti-staining agent (HQ-4) | 0.050 |
| | Anti-staining agent (HQ-5) | 0.023 |
| | DBP | 0.020 |
| | DIDP | 0.040 |
| | Surface active agent for | 0.007 |
| | dispersion (SU-1) | |
| | Hardening agent (H-1) | 0.035 |
| 1^{st} layer | Gelatin | 1.100 |
| (blue sensitive | Blue sensitive silver halide | 0.260 |
| layer) | emulsion (Em-B) | |
| wet layer | Yellow coupler (Y-1) | 0.700 |
| thickness: | Dye image stabilizing agent (ST-1) | 0.100 |
| 14.0 μm | Dye image stabilizing agent (ST-2) | 0.100 |
| | Dye image stabilizing agent (ST-5) | 0.100 |
| | Anti-staining agent (HQ-1) | 0.010 |
| | Image stabilizing agent A | 0.150 |
| | DBP | 0.150 |
| | DNP | 0.050 |
| | Surface active agent for | 0.015 |
| | dispersion (SU-1) | |
| | Surface active agent for coating | 0.015 |
| | (SU-2) | |
| Substrate | Polyethylene laminated paper (containing | |
| | a small amount of coloring agent) | |

SU-1: sodium tri-i-propylnaphthalenesulfonate
SU-2: sodium dioctylsulfosuccinate
DBP: dibutyl phthalate
DNP: dinonyl phthalate
DOP: dioctyl phthalate
DIDP: di-i-decyl phthalate
PVP: polyvinyl pyrrolidone
H-1: tetrakis (vinylsulfonylmethyl)methane
R-2: 2,4-dichloro-6-hydroxy-s-triazine · sodium
HQ-1: 2,5-di-t-octylhydroquinone
HQ-2: 2,5-di-sec-dodecylhydroquinone
HQ-3: 2,5-di-sec-tetradecylhydroquinone
HQ-4: 2-sec-dodecyl-5-sec-tetradecylhydroquinone
HQ-5: 2,5-di{(1,1-dimethyl-4-hexyloxycarbonyl)butyl}hydroquinone
Image stabilizing agent A: p-t-octylphenol

| | |
|---|---|
| Y-1 | 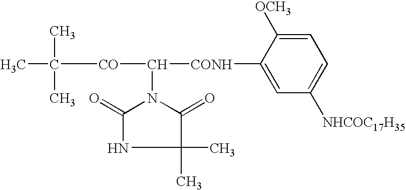 |
| M-1 | 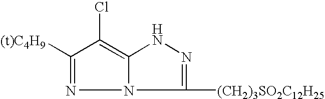 |
| C-1 | 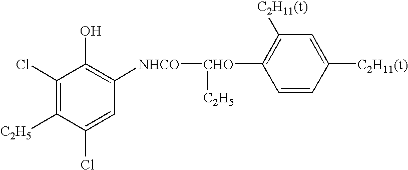 |
| C-2 | 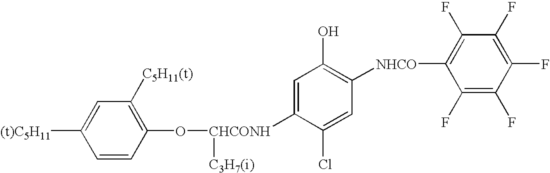 |
| ST-1 | 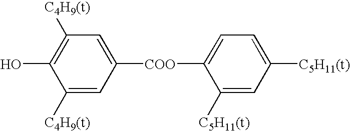 |
| ST-2 | 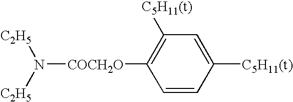 |
| ST-3 | 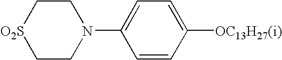 |
| ST-4 | 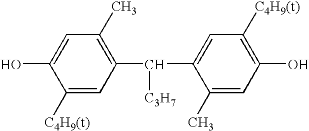 |
| ST-5 | 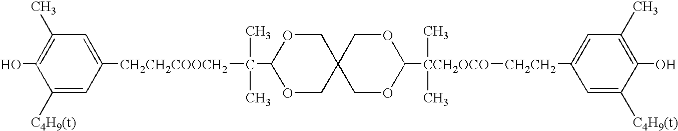 |
| UV-1 | 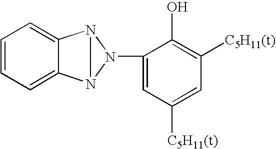 |
| UV-2 | 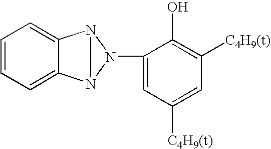 |
| UV-3 | 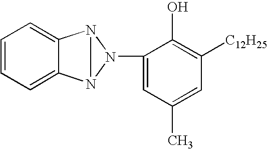 |
| AI-1 | 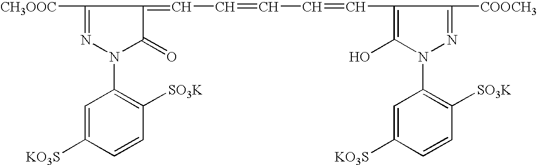 |
| AI-2 | 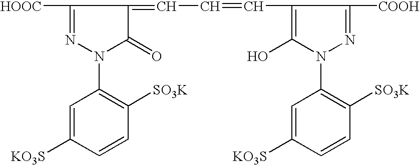 |
| AI-3 | 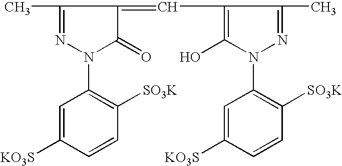 |
| F-1 | 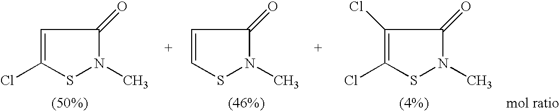 |
| BS-1 | 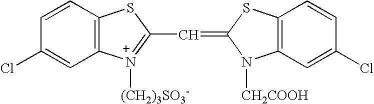 |
| BS-2 | 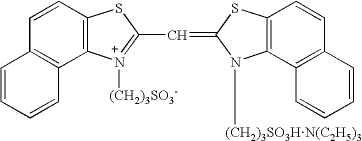 |
| GS-1 | 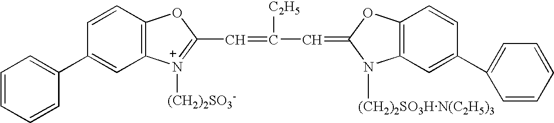 |
| RS-1 | 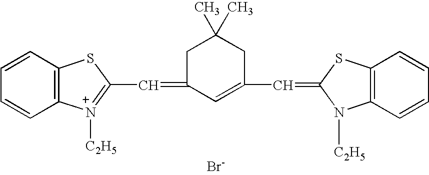 |
| RS-2 | 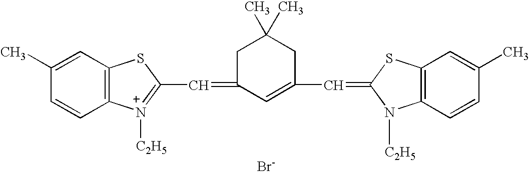 |
| SS-1 | 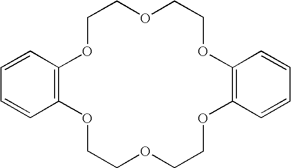 |

Preparation of Silver Halide Emulsion

Preparation of Blue Sensitive Silver Halide Emulsion

To one liter of a 2% gelatin solution maintained at 40° C., following Solutions A and B were simultaneously added over 30 min. while controlling the pAg at 7.3 and the pH at 3.0. Subsequently, following Solution C and D were simultaneously added over 180 min. while controlling the pAg at 8.0 and the pH at 5.5. In this case, control of pAg was conducted with a method described in JP-A 59-45437, while control of pH was conducted using sulfuric acid or sodium hydroxide aqueous solution.

| | | |
|---|---|---|
| Solution A | | |
| Sodium chloride | 3.42 | g |
| Potassium bromide | 0.03 | g |
| Water | to make 200 | ml |
| Solution B | | |
| Silver nitrate | 10 | g |
| Water | to make 200 | ml |
| Solution C | | |
| Sodium chloride | 102.7 | g |
| K₂IrCl₆ | 4 × 10⁻⁵ | mol/mol Ag |
| K₄Fe(CN)₆ | 2 × 10⁻⁵ | mol/mol Ag |
| Potassium bromide | 1.0 | g |
| Water | to make 600 | ml |
| Solution D | | |
| Silver nitrate | 300 | g |
| Water | to make 600 | ml |

After addition of each solution was completed, desalting was conducted using a 5% Demol N solution, available from Kao Corp., and a 20% magnesium sulfate aqueous solution, after which mixing with a gelatin solution was conducted to prepare EMP-1 of a monodispersed cubic crystal emulsion having an average particle diameter of 0.71 μm, a variation coefficient of particle size of 0.07, and a silver chloride content of 99.5 mol %.

Next, EMP-1B of a monodispersed cubic crystal emulsion having an average particle diameter of 0.64 μm, a variation coefficient of particle size of 0.07, and a silver chloride content of 99.5 mol % was prepared in the same manner as in preparation of above EMP-1, except that the addition time of (Solution A) and (Solution B), and also the addition time of (Solution C) and (Solution D) were each changed.

Subsequently, to the EMP-1 prepared as above, chemical sensitization was provided at 60° C. using the following compounds. Also, to the EMP-1B, chemical sensitization was provided in the same manner, after which the sensitized EMP-1 and EMP-1B were mixed at a ratio of 1:1, by silver content, to prepare Blue Sensitive Silver Halide Emulsion (Em-B).

| | | |
|---|---|---|
| Sodium thiosulfate | 0.8 | mg/mol AgX |
| Chloroauric acid | 0.5 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Sensitizing dye: BS-1 | 4 × 10⁻⁴ | mol/mol AgX |
| Sensitizing dye: BS-2 | 1 × 10⁻⁴ | mol/mol Agx |

STAB-1: 1-(3-acetamidephenyl)-5-mercaptotetrazole
STAB-2: 1-phenyl-5-mercaptotetrazole
STAB-3: 1-(4-ethoxyphenyl)-5-mercaptotetrazole

Preparation of Green Sensitive Silver Halide Emulsion

EMP-2 of monodispersed cubic crystal emulsion having an average particle diameter of 0.40 μm, a particle size variation coefficient of 0.08, and a silver chloride content of 99.5 mol %, and further EMP-2B of monodispersed cubic crystal emulsion having an average particle diameter of 0.50 μm, a particle size variation coefficient of 0.08, and a silver chloride content of 99.5 mol %, were prepared in the same manner as in preparation of foregoing EMP-1, except that the addition duration of (Solution A) and (Solution B), and also the addition duration of (Solution C) and (Solution B) were each changed.

To above EMP-2, chemical sensitization at 55° C. was provided using the following compounds. Also, to EMP-2B, chemical sensitization was provided in the same manner, after which sensitized EMP-2 and EMP-2B were mixed at a ratio of 1:1, by silver content, to prepare Green Sensitive Silver Halide Emulsion (Em-G).

| | | |
|---|---|---|
| Sodium thiosulfate | 1.5 | mg/mol AgX |
| Chloroauric acid | 1.0 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Sensitizing dye: GS-1 | 4 × 10⁻⁴ | mol/mol AgX |

Preparation of Red Sensitive Silver Halide Emulsion

EMP-3 of monodispersed cubic crystal emulsion having an average particle diameter of 0.40 μm, a particle size variation coefficient of 0.08, and a silver chloride content of 99.5 mol %, and further EMP-3B of monodispersed cubic crystal emulsion having an average particle diameter of 0.38 μm, a particle size variation coefficient of 0.08, and a silver chloride content of 99.5 mol %, were prepared in the same manner as in preparation of foregoing EMP-1, except that the addition duration of (Solution A) and (Solution B), and also the addition duration of (Solution C) and (Solution D) were each changed.

To the above EMP-3, chemical sensitization at 60° C. was provided using the following compounds. Also, to EMP-3B, chemical sensitization was provided in the same manner, after which the sensitized EMP-3 and EMP-3B were mixed at a ratio of 1:1, by silver content, to prepare Red Sensitive Silver Halide Emulsion (Em-R).

| | | |
|---|---|---|
| Sodium thiosulfate | 1.8 | mg/mol AgX |
| Chloroauric acid | 2.0 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Sensitizing dye: RS-1 | 1 × 10⁻⁴ | mol/mol AgX |
| Sensitizing dye: RS-2 | 1 × 10⁻⁴ | mol/mol AgX |
| Stabilizing agent: SS-1 | 2.0 × 10⁻⁵ | mol/mol AgX |

Development Processing

The samples prepared as above were subjected to wedge-exposure by the following common practice of the art, after which the samples were processed, based on the following processes and the foregoing automated processor, to evaluate magenta staining.

| | Processing | | | Tank |
|---|---|---|---|---|
| Processes | temperature | | Time | volume |
| Color development | 41.0° | C. | 25 sec. | 15.0 l |
| Bleach-fixing | 35.0° | C. | 25 sec. | 15.0 l |
| Stabilizing-1* | 35.0° | C. | 15 sec. | 12.0 l |
| Stabilizing-2 | 35.0° | C. | 15 sec. | 12.0 l |
| Stabilizing-3 | 35.0° | C. | 15 sec. | 12.0 l |
| Drying | 60-80° | C. | 15 sec. | |

(Cross-over time is 3 sec. at every process.)
*Stabilizing under a cascading counter flow of 3 → 2 → 1.

The tank solutions of the color development solution and the stabilizing are shown below.

| Color development solution: per liter | Tank solution | |
|---|---|---|
| p-toluenesulfonic acid | 10.0 | g |
| Potassium chloride | 5.0 | g |
| Sodium hydroxide | 6.0 | g |
| 4-amino-3-methyl-N-{p- | 8.5 | g |
| (methanesulfonamide)ethyl}aniline sulfate | | |
| N,N-bis(sulfoethyl)hydroxylamine disodium salt | 5.5 | g |
| Potassium carbonate | 22.5 | g |
| Diethylenetriaminepentaacetic acid | 8.0 | g |
| PH | 10.00 | |

The total volume was brought to 1 liter by addition of water, after which the pH was adjusted using potassium hydroxide or 50% sulfuric acid.

| Stabilizing solution: per liter | Tank volume | |
|---|---|---|
| 1-hydroxyethylidene-1,1-diphosphonic acid 3 sodium | 6.0 | g |
| ethylenediaminetetraacetic acid | 1.5 | g |
| o-phenylphenol | 0.1 | g |
| Sodium sulfite | 0.5 | g |
| PF | 7.0 | |

The total volume was brought to 1 liter by addition of water, after which the pH was adjusted using potassium hydroxide or 50% sulfuric acid.

Evaluation of Magenta Staining

Green density in the unexposed areas of the processed sample was measured using an X-rite densitometer, after which the samples were stored under a condition of 85° C. and 60% RH for 5 days, and then the green density in the unexposed areas was measured (being a green value of Dmini). Thus, a magenta staining value was determined from the value of the measured value after storage minus that before storage.

ΔDmini(G)=(green value of Dmini after storage)−(green value of Dmini before storage)

The test results are shown in Table 4.

TABLE 4

| | Bleach-fixing processing solution (tank solution) | | | | | | | |
|---|---|---|---|---|---|---|---|---|
| | Concentrated one-part | | | Additives | | | | |
| | bleach-fixing kit | | | | Starter (amino- | Evaluation | | |
| | One- | Amino-poly- | | | poly-carboxylic | of magenta | | |
| Exper- | part | carboxylic | | Oxidizing agent | acid Fe(III) | staining | Stability | |
| iment | kit | acid iron | Fe(II) | (added amount: | complex) (added | resistance | of tank | |
| No. | No. | complex | content | mil/l) | amount*: mol/l) | ΔDmini (G) | solution | Remarks |
| II-1 | I-1 | EDTA-FeNH₄ | 100% | Ammonium | — | 0.10 | C | Comp. |
| | | | | Persulfate (0.135) | | | | |
| II-2 | I-1 | EDTA-FeNH₄ | 100% | Hydrogen | — | 0.10 | C | Comp. |
| | | | | Peroxide (0.135) | | | | |
| II-3 | I-1 | EDTA-FeNH₄ | 100% | Sodium | — | 0.10 | C | Comp. |
| | | | | Hypochloride (0.135) | | | | |
| II-4 | I-2 | EDTA-FeNH₄ | 70% | Sodium | — | 0.10 | B to C | Comp. |
| | | | | Hypochloride (0.095) | | | | |
| II-5 | I-3 | EDTA-FeNH₄ | 50% | Sodium | — | 0.09 | B | Comp. |
| | | | | Hypochloride (0.07) | | | | |
| II-6 | I-7 | s,s-EDDS- | 50% | Sodium | — | 0.09 | B | Comp. |
| | | FeNH₄ | | Hypochloride (0.07) | | | | |
| II-7 | I-9 | DTPA-FeNH₄ | 50% | Sodium | — | 0.09 | B | Comp. |
| | | | | Hypochloride (0.07) | | | | |
| II-8 | I-1 | DTPA-FeNH₄ | 100% | — | EDTA-FeNH₄(0.135) | 0.04 | A | Inv. |
| II-9 | I-1 | DTPA-FeNH₄ | 100% | — | s,s-EDDS- | 0.04 | A | Inv. |
| | | | | | FeNH₄(0.135) | | | |
| II-10 | I-1 | DTPA-FeNH₄ | 100% | — | EDTA-FeNH₄(0.135) | 0.04 | A | Inv. |
| II-11 | I-2 | DTPA-FeNH₄ | 70% | — | EDTA-FeNH₄(0.93) | 0.04 | A | Inv. |
| II-12 | I-3 | DTPA-FeNH₄ | 50% | — | EDTA-FeNH₄(0.67) | 0.03 | A | Inv. |
| II-13 | I-7 | s,s-EDDS- | 50% | — | EDTA-FeNH₄(0.67) | 0.03 | A | Inv. |
| | | FeNH₄ | | | | | | |
| II-14 | I-9 | DTPA-FeNH₄ | 50% | — | EDTA-FeNH₄(0.67) | 0.03 | A | Inv. |

*Content in bleach-fixing processing solution (tank solution)
Note:
Comp.: Comparative sample
Inv.: This invention

As is apparent from Table 4, it was proved that not only was a depression effect for generation of magenta staining resistance obtained, but also was obtained excellent stability of the tank solution, in cases when a bleach-fixing processing solution (being a tank solution) was prepared using a starter containing an aminopolycarboxylic acid Fe(III) complex, as well as when processing was conducted using that processing solution.

### Example 3

Bleach-fixing tank solution (the pH of which was adjusted to 6.0 using ammonium hydroxide or 50% sulfuric acid) was prepared in the same manner as for Example 2, except that the amount of ethylenediaminetetraacetic acid Fe(III) ammonium salt of the starter in Experiment No. II-8 of Example 2 was changed to that described in Table 5.

Next, the samples were processed in the same manner as for Example 2, except that processing time of the bleach-fixing process was changed to 16 sec. (the cross-over time remained at 3 sec.) by modification of the processing rack of the automated processor, to evaluate magenta staining resistance. Further, edge staining resistance was also evaluated based on the following criteria. The results are shown in Table 5.

Evaluation of Edge Staining

Fifty sample L size (89×127 mm) prints of the photosensitive materials prepared as above were processed without exposure, after which the 50 samples were stacked together, and reflective blue density of all the four sides (being 4-edge portions) were measured using an X-rite densitometer, and evaluation was conducted for average density values.

TABLE 5

| | Starter | | |
|---|---|---|---|
| | Aminopolycarboxylic | Evaluation | Evaluation |
| | acid Fe(III) | of magenta | of edge |
| | complex | staining | staining |
| Experiment | (added amount*: | resistance | resistance |
| No. | mol/l) | ΔDmini (G) | Dmini (B) |
| III-1 | EDTA-FeNH₄(0.04) | 0.07 | 0.06 |
| III-2 | EDTA-FeNH₄(0.06) | 0.05 | 0.05 |
| III-3 | EDTA-FeNH₄(0.08) | 0.05 | 0.05 |
| III-4 | EDTA-FeNH₄(0.10) | 0.03 | 0.05 |
| III-5 | EDTA-FeNH₄(0.12) | 0.03 | 0.05 |
| III-6 | EDTA-FeNH₄(0.16) | 0.03 | 0.05 |
| III-7 | EDTA-FeNH₄(0.20) | 0.03 | 0.05 |
| III-8 | EDTA-FeNH₄(0.22) | 0.03 | 0.08 |
| III-9 | EDTA-FeNH₄(0.24) | 0.03 | 0.08 |
| III-10 | EDTA-FeNH₄(0.26) | 0.03 | 0.12 |
| III-11 | EDTA-FeNH₄(0.30) | 0.03 | 0.12 |

*Content in bleach-fixing processing solution (tank solution)

As is apparent from Table 5, it was proved that depression effect for generation of magenta staining was obtained in cases when the added amount of an aminopolycarboxylic acid Fe(III) complex to the starter in this invention was at least 0.06 mol/l, and specifically preferred was at least 0.10 mol/l, under the conditions of a shortened processing time of the bleach-fixing process. Further, in cases when the added amount of an aminopolycarboxylic acid Fe(III) complex was not more than 0.25 mol/l, the depression effect of magenta staining resistance was not changed, but effects of preventing edge staining resistance were obtained. Specifically, the preferable amount was proved to be at most 0.20 mol/l.

### Example 4

The bleach-fixing tank solution was prepared in the same manner as Example 3, except that the amount of ethylenediaminetetraacetic acid in the starter of Experiment No. III-4 in Example 3 was changed as shown in Table 5. Consequently, the samples were processed in the same manner as Example 3 except that the processing times of the stabilizing process were each changed to 12 sec. (for a total of 36 sec., and the cross-over times remained 3 sec. each) with modification to the processing racks of each stabilizing process. Thus, magenta staining resistance and edge staining resistance were evaluated, the results of which are shown in Table 6.

TABLE 6

| | Starter | | | |
|---|---|---|---|---|
| | | Mol ratio | | Evaluation |
| | Aminopolycar- | of amino- | Evaluation of | of |
| | boxylic acid | poly- | resistance to | resistance |
| Exper- | (added | carboxylic | magenta | to edge |
| iment | amount: | acid to | staining | staining |
| No. | mol/l) | ion ions | ΔDmini (G) | ΔDmini (B) |
| IV-1 | EDTA(0.15) | 1.00 | 0.07 | 0.13 |
| IV-2 | EDTA(0.1515) | 1.01 | 0.05 | 0.09 |
| IV-3 | EDTA(0.1545) | 1.03 | 0.03 | 0.06 |
| IV-4 | EDTA(0.1575) | 1.05 | 0.03 | 0.06 |
| IV-5 | EDTA(0.1605) | 1.07 | 0.05 | 0.08 |
| IV-6 | EDTA(0.1635) | 1.10 | 0.05 | 0.09 |
| IV-7 | EDTA(0.1665) | 1.12 | 0.07 | 0.13 |

EDTA: ethylendiaminetetraacetic acid

From Table 6 it was proved that not only favorable depression effect to resistance to magenta staining was obtained, but also excellent effects to resistance to edge staining were exhibited, in cases when the mol ratio of an aminopolycarboxylic acid such as ethylenediaminetetraacetic acid, and iron ions was set to 1.01:1.00-1.10:1.00, under conditions to reduce the processing times of bleach-fixing and stabilizing processes. Also, it was proved that the specifically preferred ranges were 1.03:1.00-1.06:1.00.

### Example 5

The pH of the starter of Experiment No. II-8 in Example 2 was changed as described in Table 7 using ammonium hydroxide or 50% sulfuric acid, and the total volume of each starter was brought to 1 liter by addition of water, and those starters were each sealed into hard plastic containers with airtight stoppers and stored at 50° C. for 2 months. The status of the starter after storage was evaluated based on the following criteria. Consequently, bleach-fixing tank solutions (the pH of the thank solution being adjusted to 6.0 using ammonium hydroxide or 50% sulfuric acid) were prepared in the same manner as for Example 2, and the processing was conducted under the same conditions as Example 3, to evaluate resistance to magenta staining and edge staining, the results of which are shown in Table 7.

Solution Storage Stability of Starter

A: No suspended solids and precipitates were observed.

B: No practical problems were evident, but slight suspended solids were observed.

C: No practical problems were evident, but some suspended solids and precipitates were observed.

D: The container was severely discolored, and precipitates were observed in the bottom of the container, at a level to result in adverse effects on processing characteristics.

TABLE 7

| | Starter | | | | |
|---|---|---|---|---|---|
| | Amino- | | | | |
| | polycarboxylic | | Evaluation | | |
| | acid Fe (III) | | of storage | Evaluation | Evaluation |
| Exper- | complex | | stability | of magenta | of edge |
| iment | (added amount: | | of | staining | staining |
| No. | mol/l) | pH | solution | ΔDmimi (G) | ΔDmimi (B) |
| V-1 | EDTA-FeNH₄ | 2.8 | C | 0.07 | 0.12 |
| | (0.134) | | | | |
| V-2 | EDTA-FeNH₄ | 3.0 | C | 0.05 | 0.09 |
| | (0.134) | | | | |
| V-3 | EDTA-FeNH₄ | 3.5 | B | 0.05 | 0.09 |
| | (0.134) | | | | |
| V-4 | EDTA-FeNH₄ | 4.0 | B | 0.05 | 0.08 |
| | (0.134) | | | | |
| V-5 | EDTA-FeNH₄ | 4.2 | B | 0.05 | 0.08 |
| | (0.134) | | | | |
| V-6 | EDTA-FeNH₄ | 4.5 | A | 0.03 | 0.05 |
| | (0.134) | | | | |
| V-7 | EDTA-FeNH₄ | 5.0 | A | 0.03 | 0.05 |
| | (0.134) | | | | |
| V-8 | EDTA-FeNH₄ | 6.0 | A | 0.03 | 0.05 |
| | (0.134) | | | | |
| V-9 | EDTA-FeNH₄ | 7 | A | 0.03 | 0.05 |
| | (0.134) | | | | |
| V-10 | EDTA-FeNH₄ | 8 | A | 0.03 | 0.05 |
| | (0.134) | | | | |
| V-11 | EDTA-FeNH₄ | 8.2 | B | 0.05 | 0.08 |
| | (0.134) | | | | |
| V-12 | EDTA-FeNH₄ | 8.5 | B | 0.05 | 0.08 |
| | (0.134) | | | | |
| V-13 | EDTA-FeNH₄ | 9 | B | 0.05 | 0.09 |
| | (0.134) | | | | |
| V-14 | EDTA-FeNH₄ | 9.2 | C | 0.07 | 0.13 |
| | (0.134) | | | | |
| V-15 | EDTA-FeNH₄ | 9.5 | C | 0.07 | 0.13 |
| | (0.134) | | | | |

From Table 7, it was proved that favorable effects of solution storage stability of the starter, depression effects to magenta staining, and prevention of edge staining were obtained, in cases when the pH of the starter was adjusted to the range of 3.0-9.0 in this invention. It was proved that specifically preferred was the pH to be in the range of 4.5-8.0.

### Example 6

The pH of the starter of Experiment No. III-4 in Example 3 was adjusted to 6.0 using ammonium hydroxide or 50% sulfuric acid, after which the total volume was brought to 1 liter by addition of water. The thus produced starter was packaged in a hard plastic container having the oxygen transmission factor described in Table 8, and then stored at 65° C. for 2 months. The status of the solution after storage was observed in the same way as in Example 5. The observed results are shown in Table 8. Plastic containers having the foregoing oxygen transmission factors were adequately prepared by control of thickness and the plastic material. Consequently, the bleach-fixing tank solution was prepared using each starter after storage, and after its pH was adjusted to 6.0 using ammonium hydroxide or 50% sulfuric acid, processing was conducted under the conditions of Example 3 to evaluate magenta staining and edge staining, the results of which are shown in Table 8.

TABLE 8

| | Starter | | | |
|---|---|---|---|---|
| | | Evaluation | | |
| | | of solution | | |
| | | storage | | |
| | Oxygen | stability | | |
| | transmission | (status of | | |
| | factor of | the | Evaluation | Evaluation |
| Exper- | packaging | solution | of magenta | of edge |
| iment | material | after | staining | staining |
| No. | (ml/m² · atm · day) | storage) | ΔDMini (G) | ΔDMini (B) |
| VI-1 | 65 | C | 0.07 | 0.12 |
| VI-2 | 55 | C | 0.07 | 0.12 |
| VI-3 | 50 | C | 0.07 | 0.12 |
| VI-4 | 40 | B | 0.05 | 0.08 |
| VI-5 | 30 | B | 0.05 | 0.08 |
| VI-6 | 20 | A | 0.03 | 0.05 |
| VI-7 | 10 | A | 0.03 | 0.05 |

From Table 8, it was proved that the favorable effects of solution storage stability of the starter, depression effects to magenta staining by processing with the stored starter, and prevention of edge staining were obtained, in cases when the starter was packaged in a container having an oxygen transmission factor of less than 40 ml/m²·atm·day. Further, it was also proved that specifically preferred was a packaging container having an oxygen transmission factor of less than 20 ml/m²·atm·day.

### Example 7

Konica Color QA Paper Type A7 produced by Konica Corp. is processed after exposure using the following processes and processing solutions by the law of the art.

Processing Process and Condition

| | | | |
|---|---|---|---|
| | Processing | Processing | Replenishing |
| Process | time | temperature | amount |

| | | | | | |
|---|---|---|---|---|---|
| Color | 20 sec. | 40.0° | C. | 60 | ml/m² |
| development | | | | | |
| Bleach-fixing | 20 sec. | 38.0° | C. | 60 | ml/m² |
| Stabilizing | 45 sec. | 35-38° | C. | 200 | ml/m² |
| (3 tank cascade) | | | | | |
| Drying | 20 sec. | 60-80° | C. | | |

Formula of Processing Solution

| Color Development Replenisher | per liter | |
|---|---|---|
| Water | 800 | g |
| Trietanolamine | 20 | g |
| Diethylene glycol | 6 | g |
| N,N-disulfoethylhydroxylamine | 8 | g |
| Sodium p-toluenesulfonate | 15 | g |
| Diethylenetriaminepentaacetic acid•5Na | 4 | g |
| Potassium chloride | 0.1 | g |
| Potassium carbonate | 30 | g |
| Potassium hydrogen carbonate | 1 | g |
| Potassium sulfite | 0.088 | g |
| Color developing agent [3-methyl-4-amino-N-ethyl- | 12 | g |
| N-(β-methanesulfonamideethyl)-aniline sulfate] | | |
| PH | 11.5 | |

The total volume was brought to 1 liter by addition of water, after which the pH was adjusted with sulfuric acid or potassium hydroxide.

| Color Development Working Solution | per liter | |
|---|---|---|
| Water | 800 | g |
| Triethanolamine | 20 | g |
| Diethylene glycol | 6 | g |
| N,N-disulfoethylhydroxylamine | 5 | g |
| Sodium p-toluenesulfonate | 15 | g |
| Diethylenetriaminepentaacetic acid•5Na | 4 | g |
| Potassium bromide | 20 | mg |
| Potassium chloride | 2.5 | g |
| Potassium carbonate | 25 | g |
| Potassium hydrogen carbonate | 5 | g |
| Potassium sulfite | 0.063 | g |
| Color developing agent [3-methyl-4-amino-N-ethyl- | 7.5 | g |
| N-(β-methanesulfonamideethyl)-aniline sulfate] | | |
| PH | 10.20 | |

The total volume was brought to 1 liter by addition of water, after which the pH was adjusted with sulfuric acid or potassium hydroxide.

Concentrated Bleach-fixing Composition

| Chelating agent A-1 | described in Table 11 | |
|---|---|---|
| Chelating agent A-1 Fe(III) complex | described in Table 11 | |
| Ferrous sulfate heptahydrate | described in Table 11 | |
| Ammonium sulfite | 0.15 | mol |
| Compound represented by Formula (A-5a) | 0.1 | mol |
| Ammonium thiosulfate (75% aqueous solution) | 162 | g |

The pH was adjusted to 5.0 with aqueous ammonia or diluted sulfuric acid, and the total volume was brought to 500 ml using water.

Bleach-Fixing Replenisher

The foregoing concentrated bleach-fixing composition was double diluted with water.

Stabilizing Solution and Replenisher

| | | |
|---|---|---|
| o-phenylphenol | 0.1 | g |
| UVITEX MST (produced by Ciba-Geigy Corp.) | 1.0 | g |
| Ammonium sulfite (40% aqueous solution) | 5.0 | ml |
| 1-hydroxyethylidene-1,1-diphosfonic acid | 3.0 | g |
| (60% aqueous solution) | | |
| ethylenediaminetetraacetic acid | 1.5 | g |

The pH was adjusted with aqueous ammonia or diluted sulfuric acid, and the total volume was brought to 1 liter using water.

Running processing was conducted using Printer-processor NPS 878QA manufactured by Konica Corp. which had been modified to satisfy the foregoing processing conditions (refer to the automated processor shown in FIGS. 1 and 2). Exposed surface area S (cm²) of gas-liquid interface of the bleach-fixing replenisher tank was changed as shown in Table 11 by providing a floating lid. Each of the processing solutions was fed into the processing tank respectively, and the foregoing color paper samples were processed, along with which the foregoing repleshisher solutions supplied using metering pumps (being bellows pumps).

Running processing was continuously conducted at 0.5 rounds per day, until the amount of the bleach-fixing replenisher supplied to the bleach-fixing processing tank reached 2 times that of the tank solution volume of 12 liters (being 2 rounds). Namely, “2 rounds” means that the bleach-fixing solution is replenished in an amount of two times the volume of the bleach-fixing processing tank. The concentrated bleach-fixing composition was prepared in advance, tightly sealed and stored. The bleach-fixing replenisher was prepared 6 L once a day in the replenisher tank using the stored composition (3 L of the concentrated composition being brought to 6 L with water). The solution circulation amount was set at 12 L/min., being 100% of the total processing solution volume.

When the running test was finished, density of blue light in the unexposed areas of the processed color paper was measured. Also, an amount of retained silver in the maximum density areas are measured using a fluorescent X-ray method. Further, the bottom of the replenisher tank was observed to evaluate whether any precipitates had been generated. The following criteria were used for evaluation.

A: No precipitates

B: Few precipitates were observed, but resulted in practically no problems

C: Substantial precipitates were observed, but had no effects on the bellows pump

D: Substantial precipitates were observed, and the bellows pump was clogged

The results of the test are shown in Table 11.

TABLE 11

| | Fe(II) | Added | Added amount | | | | | |
|---|---|---|---|---|---|---|---|---|
| | complex | amount of | of chelating | | | | | |
| | ratio in | chelating | agent V-1 | Exposed | Density | | | |
| | bleach- | agent V-1 | and ferrous | surface | of blue | Precipitates | Retained | |
| Exper- | fixing | Fe(III) | sulfate | area | light in | in | silver | |
| iment | solution | complex | heptahydrate | ratio | unexposed | replenisher | (mg/100 | |
| No. | (mol %) | (mol %) | (mol %) | (cm²/L) | areas | tank | cm²) | Remarks |
| 1-1 | 60 | 0.162 | 0.108 | 30 | 0.130 | C | 0.8 | Comp. |
| 1-2 | 60 | 0.162 | 0.108 | 50 | 0.105 | B | 0.2 | Inv. |
| 1-3 | 60 | 0.162 | 0.108 | 80 | 0.085 | A | 0.2 | Inv. |
| 1-4 | 60 | 0.162 | 0.108 | 250 | 0.080 | A | 0.2 | Inv. |
| 1-5 | 60 | 0.162 | 0.108 | 400 | 0.075 | B | 0.2 | Inv. |
| 1-6 | 60 | 0.162 | 0.108 | 500 | 0.080 | C | 0.3 | Inv. |
| 1-7 | 60 | 0.162 | 0.108 | 600 | 0.090 | D | 0.4 | Comp. |
| 1-8 | 40 | 0.162 | 0.108 | 80 | 0.110 | B | 0.2 | Comp. |
| 1-9 | 50 | 0.135 | 0.135 | 80 | 0.085 | A | 0.2 | Inv. |
| 1-10 | 70 | 0.081 | 0.189 | 80 | 0.075 | A | 0.2 | Inv. |
| 1-11 | 80 | 0.054 | 0.216 | 80 | 0.080 | A | 0.4 | Inv. |
| 1-12 | 100 | 0 | 0.27 | 80 | 0.083 | B | 0.6 | Inv. |
| 1-13 | 70 | 0.120 | 0.280 | 80 | 0.154 | D | 0.2 | Comp. |
| 1-14 | 70 | 0.030 | 0.070 | 80 | 0.084 | B | 0.2 | Inv. |
| 1-15 | 70 | 0.015 | 0.035 | 80 | 0.075 | B | 0.4 | Inv. |
| 1-16 | 70 | 0.012 | 0.028 | 80 | 0.102 | C | 1.5 | Comp. |

Note:
Comp.: Comparative example
Inv.: This invention

From Table 11 it is proved that no precipitates were observed in the replenisher tank and excellent photographic characteristics can be obtained even during continuous large quantity processing, under conditions that the exposed surface area ratio of the replenisher tank is set at 50-500 cm²/L and the aminopolycarboxtlic acid Fe(II) complex is not less than 50 mol %.

### Example 8

In No. 3 of Example 7, the replenishing amount of the bleach-fixing solution was changed as in Table 12, and experiments similar to Example 7 were conducted.

TABLE 12

| | | Density of | | |
|---|---|---|---|---|
| | | blue light | Precipitates | Retained |
| Exper- | Replenishing | in | in | silver |
| iment | amount | unexposed | replenisher | (mg/100 |
| No. | (ml/m²) | areas | tank | cm²) |
| 2-1 | 15 | 0.093 | C | 0.5 |
| 2-2 | 20 | 0.088 | B | 0.3 |
| 2-3 | 30 | 0.085 | A | 0.2 |
| 2-4 | 50 | 0.085 | A | 0.2 |
| 2-5 | 80 | 0.082 | A | 0.2 |
| 2-6 | 120 | 0.085 | B | 0.4 |
| 2-7 | 150 | 0.090 | B | 0.7 |

Table 12 proved that no precipitates were observed in the replenisher tank and excellent photographic characteristics can be obtained even in continuous large quantity processing, in cases when the replenishing amount of the bleach-fixing solution is 20-120 ml per m² of the photosensitive material.

### Example 9

In No. 3 of Example 7, the solution circulation amount of the bleach-fixing solution was changed as in Table 13, and experiments similar to Example 7 were conducted.

TABLE 13

| | | Density of | |
|---|---|---|---|
| | Solution | blue light in | Retained |
| Experiment | circulation | unexposed | silver |
| No. | amount (%) | areas | (mg/100 cm²) |
| 3-1 | 30 | 0.095 | 0.5 |
| 3-2 | 50 | 0.088 | 0.3 |
| 3-3 | 100 | 0.085 | 0.2 |
| 3-4 | 250 | 0.085 | 0.2 |
| 3-5 | 300 | 0.090 | 0.2 |
| 3-6 | 350 | 0.095 | 0.2 |

Table 13 proved that excellent photographic characteristics could be obtained even in continuous large quantity processing, in cases when the solution circulation amount of the processing tank of the bleach-fixing solution is 50-300% of the total processing solution per minute.

### Example 10

In No. 3 of Example 7, the compounds represented by Formula (A) were added as in Table 14.

TABLE 14

| | | Added | | |
|---|---|---|---|---|
| | | amount of | Density of | |
| | Compound | compound | blue light | Precipitates |
| Exper- | represented | of Formula | in | in |
| ience | by Formula | (A) | unexposed | replenisher |
| No. | (A) | (mol/L) | areas | tank |
| 4-1 | A-5a | 0.050 | 0.094 | A |
| 4-2 | A-5a | 0.200 | 0.085 | A |
| 4-3 | A-5a | 0.400 | 0.081 | A |
| 4-4 | A-5a | 0.600 | 0.081 | B |
| 4-5 | A-5a | 0.800 | 0.080 | C |
| 4-6 | A-5b | 0.200 | 0.080 | A |
| 4-7 | A-26 | 0.200 | 0.081 | A |

Table 14 proved that the effects of this invention were quite noticeable when the compounds represented by Formula (A) were incorporated.

### Example 11

Into a hard plastic container having a volume of 1.2 l and an oxygen transmission factor of 40 ml/m²·atm·day, the starter was filled to become the amount of ammonium ethylenediaminetetraacetic acid Fe(III) (EDTA-FeNH₄) per liter of the starter as described in Table 15 by addition of water. The pH of the starter was adjusted to 6.0. Subsequently, the starters were evaluated for the following characteristics, the results of which are shown in Table 15.

Evaluation of Precipitation at Low Temperature

To each of the starters prepared above, 80 mg of EDTA-FeNH₄.dihydrate crystal was added, and sealed in the hard plastic container. After storage at −5° C. for one week, precipitation at that low temperature was visually evaluated based on the following criteria.

A: No increase of crystals was observed.

B: No practical problems were evident, but a slight increase of crystals was observed.

C: A large increase of precipitated crystals was observed.

Evaluation of Storage Stability at a High Temperature

Each of the starters prepared above was sealed in an airtight stopper, and stored at 65° C. for two months in a thermostatically controlled chamber. The status of the solutions was visually observed, and storage stability at a high temperature was evaluated based on the following criteria.

A: No suspended solids nor precipitates were observed.

B: No practical problems were evident, but a slight amount suspended solids were observed.

C: No practical problems were evident, but some suspended solids and precipitates were observed.

D: The container was severely discolored, and precipitates were observed in the bottom of the container.

TABLE 15

| | Starter | | |
|---|---|---|---|
| | Added | | Storage |
| | amount of | Precipitation | stability at |
| Experiment | EDTA-FeNH₄ | at low | high |
| No. | (mol/l) | temperature | temperature |
| IX-1 | 0.2 | A | A |
| IX-2 | 0.3 | A | A |
| IX-3 | 0.5 | A | A |
| IX-4 | 1.0 | A | B |
| IX-5 | 1.8 | A | B |
| IX-6 | 2.0 | A | B |
| IX-7 | 2.2 | B | C |

As is apparent from Table 15, it was proved that the content of the starter was preferably less than 2.0 mol/l from the viewpoint of precipitation at a low temperature and storage stability at a high temperature. However, in cases when the content was less than 0.2 mol/l, the volume of the starter became too great to be making it undesirable from the point of view of handling.

Based on the present invention, it is possible to provide a method for processing of a photographic light sensitive material using a concentrated one-part bleach-fixing composition, in which precipitates in the replenisher tank are prevented, and fogging generation in unexposed areas of color paper processing is reduced.

What is claimed is:

1. A method for preparing a bleach-fixing processing solution for a silver halide color photographic light sensitive material, the method comprising the step of:
mixing a concentrated one-part bleach-fixing composition with a starter,
wherein the concentrated one-part bleach-fixing composition contains an iron salt having an Fe(II) content of 50 to 100 mol % based on the total mol of the iron salt; and the starter contains an aminopolycarboxylic acid Fe(III) complex.

2. The method according to claim 1, wherein the content of the aminopolycarboxylic acid Fe(III) complex is in the range of 0.06 to 0.25 mol per liter of the bleach-fixing processing solution, the content of which is obtained by addition as the starter.

3. The method according to claim 1, wherein a pH value of the starter is in the range of 3.0 to 9.0.

4. The method according to claim 1, wherein a mol ratio of the total aminopolycarboxylic acid to the total iron ions in the starter is in the range of 1.01:1.00 to 1.10:1.00.

5. A method for processing of silver halide color photographic light sensitive material using a processing solution described in claim 1, wherein:
the processing solution is prepared from a replenisher which is prepared by using the one-part concentrated bleach-fixing composition,
the replenisher contains at least 0.05 to 0.35 mol/l of aminopolycarboxylic acid iron complex,
at least 50 mol % of the aminopolycarboxylic acid iron complex is an Fe(II) complex, and
an exposed surface area ratio of a bleach-fixing replenisher tank is 50 to 500 cm²/l.

6. The method according to claim 5, wherein an amount of Fe(II) complex in the aminopolycarboxylic acid iron complex is not less than 70 mol %.

7. The method according to claim 5, wherein a replenishing amount of the replenisher is 20 to 120 ml per m² of the photographic light sensitive material.

8. The method according to claim 5, wherein a solution circulation amount in the bleach-fixing processing tank is 50 to 300% per minute based on the total processing solution volume per minute.

9. The method according to claim 5, wherein a concentration factor of the one-part concentrated bleach-fixing composition is 1.2 to 5.

10. A starter for the one-part concentrated bleach-fixing composition for silver halide color photographic light sensitive material, containing an iron salt having an Fe(II) content of 50 to 100 mol %, wherein the starter contains aminopolycarboxylic acid Fe(III) complex.

11. The starter according to claim 10, wherein content of polyaminocarboxylic acid Fe(III) complex in the starter is in the range of 0.2 to 2.0 mol/l.

12. The starter according to claim 10, wherein a pH value of the starter is in the range of 3.0 to 9.0.

13. The starter according to claim 10, wherein the mol ratio of the total aminopolycarboxylic acid to the total iron ions in the starter is in the range of 1.01-1.00 to 1.10-1.00.

14. A method for processing a silver halide color photographic light sensitive material using a bleach-fixing processing solution prepared by the method for preparation of the bleach-fixing processing solution described in claim 1.

15. The method according to claim 14, wherein at least 90 mol % of silver halides in the silver halide color photographic light sensitive material is silver chloride.

16. A method for processing a silver halide color photographic light sensitive material, wherein the starter described in claim 10 is packed into a package material having an oxygen transmission factor of not more than 400 ml/m²·atm·day.
